(19) United States
(12) Patent Application Publication
(10) Pub. No.: US 2024/0393825 A1
(43) Pub. Date: Nov. 28, 2024

(54) Chip-to-Chip Flit Rate Synchronization

(71) Applicant: Groq, Inc., Mountain View, CA (US)

(72) Inventors: James Sproch, Monte Sereno, CA (US); Matthew Boyd, Portland, OR (US)

(21) Appl. No.: 18/670,213

(22) Filed: May 21, 2024

Related U.S. Application Data
(60) Provisional application No. 63/503,570, filed on May 22, 2023.

(51) Int. Cl. G06F 1/12; G06F 1/10

(52) U.S. Cl. CPC G06F 1/12; G06F 1/10

(57) ABSTRACT

Systems and circuits are disclosed for synchronizing processor clocks in a network of processors by using the method of Flit Rate Synchronization, where counts of flits (a unit of data) sent and received by processors are used to determine if a child processor in a network needs to increase or decrease the speed of its clock. Other systems and circuits are disclosed for Beacon Rate Synchronization that use a periodic beacon to eliminate relative drift between processors by applying a small adjustment to selected clock periods on a child processor in order to maintain a constant distance between arrival times of a periodic time beacon sent by a parent processor. This Abstract and the independent Claims are concise signifiers of embodiments of the claimed inventions. The Abstract does not limit the scope of the claimed inventions.

### CROSS-REFERENCE TO RELATED APPLICATIONS

This application claims the benefit of priority to U.S. Provisional Application No. 63/503,570, filed May 22, 2023, and entitled “C2C Flit Rate Synchronization,” the entirety of which is expressly incorporated herein by reference.

This application is also related to commonly assigned, co-pending U.S. Non-Provisional patent application Ser. No. 18/323,188 filed May 24, 2023, entitled “Clock Period Synthesis For Fine-grain Power Management,” the entirety of which is expressly incorporated herein by reference.

### SPECIFICATION-DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

This disclosure has general significance in the field of a scalable high performance interconnect networking for parallel deterministic computer architecture. This information is limited to use in the searching of the prior art.

### BACKGROUND

Network topologies refer to the physical or logical arrangement of nodes and connections in a computer network. Network topologies determine how devices (e.g., User Equipment (UE) in a network are interconnected and how data flows between the devices. Different network topologies have different advantages and disadvantages in terms of scalability, fault tolerance, cost, and performance. Some common network topologies include bus topology, star topology, ring topology, mesh topology, tree topology, and hybrid topology.

In a bus topology, all devices are connected to a single communication line, known as a bus. Data is transmitted in both directions along the bus, and each device receives all transmissions but only processes the data intended for it (e.g., as identified in a data header, for example).

In a star topology, each device is connected to a central hub or switch. All data traffic passes through the hub, which facilitates communication between devices. If one device fails, this failure does not affect the other devices in the network.

In a ring topology, devices are connected in a circular manner, forming a closed loop. Each device is connected to its adjacent devices, and data travels in one or both direction(s) around the ring. A ring topology requires a token passing mechanism to regulate data transmission.

In a mesh topology, every device is connected to every other device in the network. The mesh topology provides multiple paths for data to travel, resulting in high redundancy and fault tolerance. Mesh topologies can be full mesh (direct connection between every pair of devices) or partial mesh (only some devices have direct connections).

A tree topology, also known as a hierarchical topology, resembles a tree structure. The tree topology includes multiple levels of interconnected devices, with a central root node at the top. Data flows from higher-level nodes to lower-level nodes in the tree topology.

Hybrid topologies combine two or more network topologies to leverage their respective benefits. For example, a hybrid topology might have a combination of star and mesh topologies.

The term “flit” stands for “flow control unit” or “flow control digit” and is generally used with high-performance computer networks. A flit is the smallest unit of data that can be transferred within a network. Thus, a flit represents a fraction of a packet and typically carries a few bits or bytes of information. Flits are used in network-on-chip architectures and parallel computing systems to enable efficient data transfer and flow control between network nodes.

In a deterministic network, it is important to synchronize the nodes so the clock at each node is aligned to the rate of reception of flits from the parent in a spanning tree.

### SUMMARY

This Summary, together with any Claims, is a brief set of signifiers for at least one Embodiment of a Claimed Invention (ECIN), which can be a discovery (see 35 USC 100 (a) and see 35 USC 100 (j)), for use in commerce for which the Specification and Drawings satisfy 35 USC 112.

In one or more ECINs disclosed herein, a Chip-to-Chip (C2C) Flit Rate Synchronization (FRS) method, apparatus, and/or other ECINs is configured to count the total number of flits received on a C2C link to a spanning tree parent of a particular tensor streaming processor (processor) or other device such as an FPGA. In an example, the counting begins from a time of a most recent topology-wide Global Notify event.

In one or more ECINs disclosed herein, at the beginning of a program executing on the at least two processors, a Global Notify event is executed for all chips participating in a topology. The total number of flits received is compared to the expected number of flits that was calculated at the time the program was compiled. If the difference is approximately zero, then the parent and child chips are aligned. If fewer flits are received than expected, then one or a few clock periods can be lengthened to slow down a processor relative to its parent. If more flits are received than expected, then one or a few clock periods can be shortened to speed up a processor relative to its parent. Each processor has a single parent link in the spanning tree constructed for a particular topology, other than the root processor of the spanning tree which has no parent.

In one or more ECINs disclosed herein, multiple processor device synchronization use a hardware-only (HW-only) Beacon Rate Synchronization (BRS) apparatus that provides a periodic beacon to eliminate relative drift between devices. The basic approach for this HW-only C2C Beacon Rate Synchronization (BRS) method is to intermittently apply a small adjustment to selected clock periods on a child device in order to maintain a constant distance between arrival times of a periodic time beacon sent by a parent device.

In one or more ECINs disclosed herein, to align the device's chip clock and the rate of reception, the hardware apparatus determines a difference between a total number of flits received and an expected number of flits calculated at compile time. For example, based on the difference being approximately zero, the apparatus determines the processor chip clock and the rate of reception are aligned. In another example, based on a result of the difference indicating that fewer flits are received than expected, the apparatus lengthens one or more clock periods to slow the processor chip clock relative to the parent. In a further example, based on a result of the difference indicating that more flits are received than expected, the apparatus shortens one or more clock periods to speed up the processor chip clock relative to the parent.

In one or more ECINs disclosed herein, the flits are flow control units or flow control digits. The flits are the smallest units of data capable of being transferred within a network. For example, each flit of the flits represents a fraction of a packet that transports a few bits or a few bytes of information.

Another ECIN relates to an electronic structure for a processor such as tensor processor, for example, a Tensor Streaming Processor commercially available from Groq, Incorporated. The electronic structure includes at least two such processors and may include multiple FPGA devices enabled to align a child processor chip clock to a rate of reception of flits from a parent processor in a spanning tree.

In one or more ECINs disclosed herein, to align the processor, tensor processor and/or other device chip clock and the rate of reception, the hardware apparatus determines a difference between a total number of flits received and an expected number of flits calculated at compile time. For example, based on a result of the difference being approximately zero, the apparatus determines the device chip clock and the rate of reception are aligned. In another example, based on a result of the difference indicating that fewer flits are received than expected, the apparatus lengthens one or more clock periods to slow the child device chip clock relative to the parent. In yet a further example, based on the difference indicating that more flits are received than expected, the apparatus shortens one or more clock periods to speed up the child device chip clock relative to the parent.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF THE DRAWINGS

The following Detailed Description, Figures, and Claims signify the uses of and progress enabled by one or more ECINs. All of the Figures are used only to provide knowledge and understanding and do not limit the scope of any ECIN. Such Figures are not necessarily drawn to scale.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

FIG. 1 illustrates a system that comprises devices connected by a Chip-to-Chip (C2C) communication interface according to one or more embodiments described herein.

FIG. 2 illustrates a block diagram of communication between two devices via a C2C interface according to one or more embodiments described herein.

FIG. 3A illustrates a system in which distinct, mesochronous clock domains are represented for four devices according to one or more embodiments described herein.

FIG. 3B illustrates the system of FIG. 3A where the view from logic is represented according to one or more embodiments described herein.

FIG. 4 illustrates a simplified diagram for network synchronizers used in communication equipment timing cards and line cards according to one or more embodiments described herein.

FIG. 5 illustrates a circuit diagram for a system having Global Time Synchronization without coax according to one or more embodiments described herein.

FIG. 6 illustrates a system for compiling programs to be executed on a tensor processor, and for generating power usage information for the compiled programs, according to one or more embodiments described herein.

FIGS. 7A and 7B illustrate instruction and data flow in a processor having a functional slice architecture, according to one or more embodiments described herein.

FIG. 8 illustrates an exemplary CPS circuit that is physically implemented in Chip Control Unit (CCU), as part of the PLL/Clock Control Module, and the CPS ICU uses the nearest, most appropriate ICU block according to one or more embodiments described herein.

FIG. 9A and FIG. 9B illustrate computer systems suitable for enabling embodiments of the claimed inventions.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures, or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures, or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

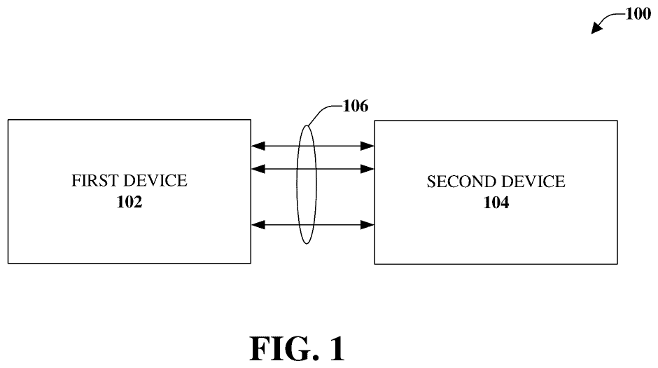

FIG. 1 illustrates a system 100 that comprises devices connected by a Chip-to-Chip (C2C) communication interface according to one or more embodiments described herein. Illustrated are a first device 102 and a second device 104 connected via one or more C2C communication interfaces 106.

The Chip-to-Chip (C2C) communication interface is a custom-designed interface that enables communication between multiple devices, including ASICs, FPGAs, and processor cores, while maintaining deterministic guarantees and a unified view from the software perspective. The interface is based in part on a SERDES transmitter and receiver circuit, along with custom logic. The C2C link appears as a bundle of streams with a fixed-length delay between chips, allowing for efficient communication between devices. The interface is designed to operate in various scenarios, including single-board, single-clock and multi-board, multi-clock configurations. The C2C link is designed to provide a deterministic and synchronous communication channel, where each die appears as a synchronous core to software, with a fixed latency between them. The interface is designed to operate in the presence of clock uncertainty, jitter, and phase mismatches, ensuring reliable and efficient communication between devices.

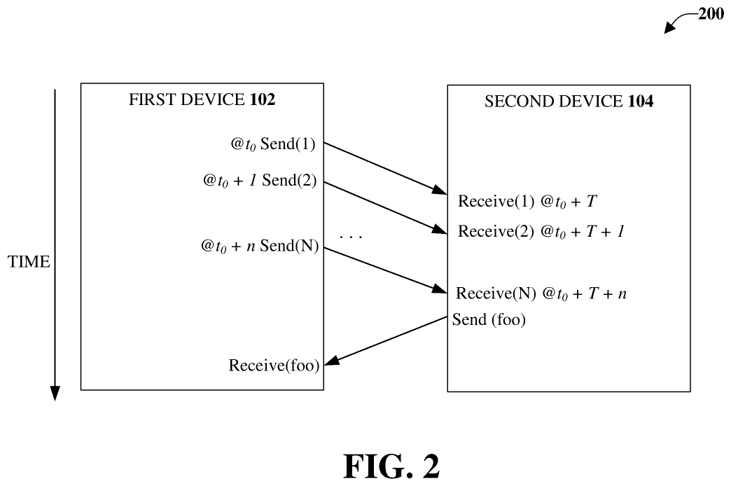

As illustrated in FIG. 2, a block diagram illustrates the communication between two devices, device 102 and device 104, which are in communication with each other via a C2C interface. Send and receive transactions that occur across the C2C interface with a first flit being sent by device 102 at time t0. Device 104 receives the flit at time t0+T, where T is the transmission time. As time progresses, as illustrated by the Time arrow, a second flit is sent by device 102 at time t0+1, which is received at device 104 at time t0+T+1, and so on until device 102 has sent all of the N indicated flits.

Once device 104 has received the N flits, an acknowledgment (Send (foo)) is sent to confirm receipt of the N flits. The Send (foo) flit is a special flit that is used to acknowledge the receipt of a sequence of flits. It is a flit that contains a confirmation of the receipt of the flits, and is used to ensure that the sender knows that the packet has been received. Each device knows how many flits it needs to send or receive, allowing for efficient communication between the two devices.

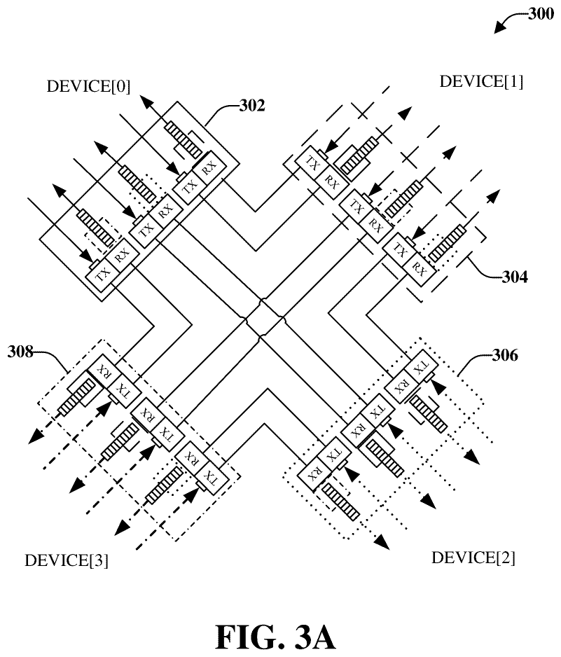

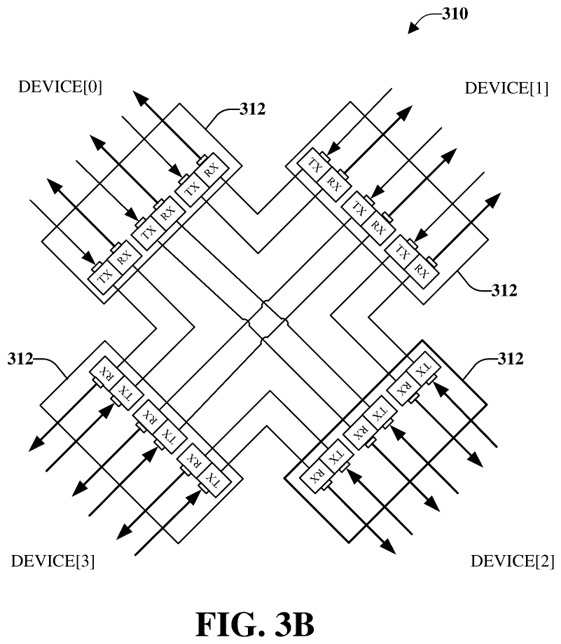

In FIG. 3A, distinct, mesochronous clock domains are represented for the four devices. To illustrate, on DEVICE [0] as indicated by Clock Domain0 is the core clock, while Clock Domain1, Clock Domain2, and Clock Domain3 are clocks recovered from the RX side of each of its three SerDes at Devices [1]-[3] respectively. The recovered clocks should match the frequency of the transmitting device, but with additional skew and jitter. Each of the core clocks are also plesiochronous, but are further skewed than the recovered clocks. In this complex clocking scenario in a multi-device system “mesochronous clock domains” means that each device has its own unique clock signal, which is not perfectly synchronized with the others. The solid line illustrating Device [0] defines a clock signal representing the core clock of Device [0], which is the primary clock signal for the device. As illustrated in FIG. 3A, The dotted lines for Device [0]-[3] define the clock domains of each device representing different clock signals.

In FIG. 3B, the view from logic is represented, where each device (e.g., Device [0]-[3]] appears to be synchronous. The Devices [1]-[3] clock signals are recovered from the RX (receiver) side of each of the three SerDes (serializer/deserializer) channels on Device [0]. These clocks are recovered from the received data and are expected to match the frequency of the transmitting device. However, these recovered clocks have additional skew and jitter, meaning they are not perfectly synchronized wit. the core clock.

Furthermore, each of the core clocks are also plesiochronous, meaning they are not perfectly synchronized with each other. They are further skewed, meaning they have additional timing differences. Despite these timing differences, FIG. 3B shows the view from the logic level, where each device appears to be synchronous. This means that the clock signals are synchronized at the logic level, allowing the devices to communicate with each other.

The tensor streaming processor (TSP) sold by Groq Incorporated is an architecture with 220 MiBytes (1 MiByte is 2-20 bytes) of local storage for parameters and instruction text. Programs that require more local storage can be processed by adding processor chips and interconnecting them using C2C links to increase both compute (e.g., functional units such as ALUs) and memory and network bandwidth to tackle larger processing models.

### Conventional Networking Structure

Conventional networks provide a simple abstraction for communication between a pair of processors, A and B, in the system (e.g., Infiniband's queue-pair abstraction). For example, consider a simple remote transaction where Processor A sends a message like ‘read the value of address X’ to Processor B, which upon receipt issues a DRAM read and sends the resulting reply back to Processor A incurring one round-trip network latency.

With a software-defined networking approach, half of the network traffic is eliminated because it is known when to send the reply (X) message to the expectant Processor A, eliminating the “request” leg of the protocol traffic. In this way, a “remote read” is initiated from another processor in the system, and from a programming model perspective, where the tensor comes from (local versus remote memory) is irrelevant.

This software-defined network provides more global bandwidth than best-known GPU solutions without any external switch chips. The net result is a cost-efficient system with lower system power, and higher global bandwidth (e.g., a 16-processor system has 33% more global bandwidth than a 16-GPU DGX2 system, with 800 GB/s versus 600 GB/s). More specifically, the network provides the same throughput as a fat-tree network with half the number of links, and no additional switch chips. One such software-defined network, the Dragonfly network, is two times more efficient from a cost per unit of bandwidth and power ($/Gbps/W) basis. Further the network provides an energy-efficient way to run models with larger parameter requirements-scaling up the number of devices simultaneously adds ALU throughput, as well as memory and network bandwidth. Ideally suited to exploit rack-scale and row-scale parallelism, where the global bandwidth is partitioned to take advantage of the packaging locality (wire density) at different tiers of the packaging hierarchy. The Dragonfly network provides the benefit of adaptive routing (load balancing) without the complexity of deadlock-avoidance, message reassembly, and tree saturation that arises in conventional Ethernet or Infiniband packet-switched networks.

The Dragonfly network allows the devices in the system to efficiently (without synchronization) communicate synchronously. As a result, there is no wasted execution time incurred from barrier synchronization across the entire network. Prior work [Gshard] has shown that 90% of the communication time incurred is by waiting for a barrier to complete.

By keeping the network diameter low, the entire system operates pseudo-synchronously under explicit software control, eliminating the need for periodic synchronization. It also provides more global bandwidth without any additional switching chips like a conventional fat-tree (folded-Clos) network. The term “network diameter” refers to the maximum number of hops or edges that a packet or message must traverse to reach its destination node in a network. In other words, it is the maximum distance between two nodes in the network. In a network, the diameter is typically measured in terms of the number of hops or edges that a packet must traverse to reach its destination node. For example, if a packet must traverse 3 edges or hops to reach its destination node, the network diameter is 3.

The Dragonfly network uses only half the number of links as a comparable fat-tree network, yet provides the same throughput (global bandwidth). In addition, our communication protocol provides another two-times improvement by eliminating half the network traffic (the “request” protocol traffic). Higher network bandwidth directly reduces the communication transfer time, and eliminates barrier synchronization delays (90% of incurred communication time is spent waiting for the barrier synchronization to complete). These two features combine to give the network a four-times advantage on $/Gbps, and ten-times latency and efficiency improvement over fat-tree equivalents with asynchronous communication. The net result is both lower training time and resulting lower energy consumption, since Energy=Power Consumed×Execution Time, making it important to both reduce the network power and reduce communication time for a dramatic reduction in overall energy consumed. The four links from each of the processors provide the 32-ports of a “virtual router” among the other three dimensions of packaging hierarchy as summarized in the Table below.

Summary of Table 1: Examples of scale and system packaging (details on p. 19)

| | | | Scale | |
|---|---|---|---|---|
| | Dimension | Ports | (processors) | Description |
| Local | Local node | 7 local | 8 | Seven (7) 30 Gbps links from each |
| | | 8 × 4 | | processor 100 in the local group of eight |
| | | global | | (8). 60 GB/s of network bandwidth per |
| | | | | processor. |
| Global | Rack-scale | 16 global | 72 | Up to nine (9) 4 U node chassis |
| | (Dim. 0) | | | interconnected by two (2) links to each of |
| | | | | eight peer nodes (16 ports) |
| | Row-scale | 8 global | 648 | Up to nine (9) cabinets in the same row are |
| | (Dim. 1) | | | fully interconnected (8 ports) |
| | System-scale | 8 global | 5,832 | Up to nine (9) rows interconnected among |
| | (Dim. 2) | | | their columns for a two-dimensional |
| | | | | cabinet grid of 9 × 9. |

When the processors are TSPs from Groq, the resulting network has a flat global bandwidth profile of 50 GB/s across all processors in the same rack (72 processors). The next tier in the packaging hierarchy is a collection of cabinets or “racks” in the same row, or row-scale with 25 GB/s among the 648 processors in the same row. Links between cabinets in the row can be connected (“double-up”) to use all the available bandwidth for a flat global bandwidth of 50 GB/s across the 648 processors of the same row, e.g., a “row-scale” network. Alternatively, the remaining 8 ports on each router connect respective chassis in the same “column” of a 9×9 cabinet grid on the datacenter floor. This provides a flat global bandwidth profile of 25 GB/s among the 5,832 processors, with a worst-case diameter of only 5 hops, or approximately 2 μs.

The Dragonfly network enables large parameter models to be handled by networked processors by scaling the synchronous network to large node counts. Importantly, the network can be flexibly provisioned depending on the Service License Agreement (SLA), latency threshold (responsiveness), and memory requirements for parameters. One such system can be viewed as a 5,832 processor single-system for large-scale training applications (for example, training during non-peak usage hours and inference workloads during the busy periods of a diurnal usage cycle of the datacenter). The system can also be viewed, at a finer-granularity as a collection of 81 racks each with 72 processors (and possibly an equal or greater number of other FPGA devices) yielding 15 GBs of shared SRAM (and possibly massive amounts of DRAM coupled to the processors through the FPGAs) over which to spread the model layers and take advantage of model and pipelined parallelism. This can, for example, use 72-way model parallelism within the cabinet and 81-way data-parallelism across independent cabinets. For an even larger memory footprint, the system can scale up to a row of cabinets (72×9) containing 648 processors and 142 GB of globally accessible SRAM. In one example system using TSP processors available from Groq, nine such row-sized regions for large models are used. For the gigantic models, embeddings span 5,832 processors and 1.2 TB of globally accessible SRAM, providing 1.1 ExaFlops (FP16) of peak performance, within approximately 100 square meters of datacenter floor space, providing a computationally-dense substrate for deploying a variety of machine learning workloads with varying degrees of parallelism and parameter space.

### C2C Flit Rate Synchronization (C2C Frs)

In a network of processors performing deterministic calculations, it is important to synchronize the nodes so the clock at each child processor is aligned to the rate of reception of flits from a parent processor in a spanning tree. Various embodiments of systems and circuitry to enable this alignment are described below.

In one ECIN to enable C2C FRS, a digital circuit is configured to count the total number of flits received on the C2C link to a spanning tree parent of a particular child processor, starting from the time of the most recent topology-wide Global Notify event. In an embodiment, a Global Notify event is executed for all processors connected in a topology at the beginning of a program. The total number of flits actually received is compared to the expected number of flits that was calculated at compile time (and stored on the processor). If the difference is approximately zero, then the two processor chips are aligned. If fewer flits are received than expected, then one or a few clock periods can be lengthened to slow down a child processor relative to its parent. If more flits are received than expected, then one or a few clock periods can be shortened to speed up a child processor relative to its parent. Each processor has a single parent link in the spanning tree constructed for a particular topology, other than the root processor of the spanning tree, which has no parent and thus defines the singular operating reference rate for the entire network topology.

Traditionally, network topology is represented using graph theory. In graph theory, a graph is a mathematical object (that can be represented with a machine-readable data structure) that consists of nodes and edges. Nodes, also referred to as vertices, represent points or locations in the graph, which can symbolize devices, computers, or other entities in a network. Edges, on the other hand, represent the connections or relationships between nodes, which can symbolize communication links, roads, or other types of connections. In the context of computer networks, a graph can represent the network topology, where nodes represent devices, and edges represent the connections between them.

A spanning tree is a graph data structure that plays a crucial role in ensuring the efficient and reliable transmission of data between devices. In the context of spanning trees, edges play a crucial role. A spanning tree is constructed by selecting a subset of edges from the original graph, ensuring that all nodes are connected, e.g., every node is reachable from every other node, and no cycles exist, e.g., no loops or cycles in the graph. This is achieved by selecting a subset of edges that connect all nodes in the graph, ensuring that data can flow efficiently and reliably between devices. In other words, a spanning tree is a subgraph that preserves the connectivity of the original graph while eliminating cycles (also referred to as loops), where a cycle is a path that starts and ends at the same node, and passes through at least one edge. In the original graph, cycles can cause problems like packet circulation and network congestion. The spanning tree eliminates these cycles by removing edges that create loops.

When used in computer networks, a spanning tree prevents network loops (packets circulating indefinitely between devices and causing network congestion and packet loss), ensures network connectivity and reliability, and optimizes network performance and reduce congestion. For instance, the Spanning Tree Protocol (STP) is a standard protocol used in Ethernet networks to prevent network loops and ensure network connectivity. Similarly, Rapid Spanning Tree Protocol (RSTP) is an enhancement to STP that reduces network downtime during topology changes. Additionally, Multiple Spanning Tree Protocol (MSTP) is used in VLANs (Virtual Local Area Networks) to manage multiple spanning trees.

In some of the embodiments disclosed herein, the C2C Flit Rate Synchronization processes and circuits include: 1. Measuring and tracking what really matters; 2. Changing what you have control of; 3. Structural stability; 4. Rate initialization using Global Notify; 5. Offset alignment; 6. Heuristics; 7. Flit Counter in Clock Controller; 8. Flit Counter in the C2C receiver configured to be a child; 9. Flit support in the C2C transmitter configured to be a parent; and 10. Flit Time Marker Approach. These various elements are described in further detail below.

### First Element: 1. Measuring and Tracking What Really Matters.

In this case, the total number of flits received during program execution is a value measured by digital circuits (such as counters) that is crucial to maintaining alignment with other connected processors, especially for deterministic calculations. Flit Rate Synchronization measures the number of flits received over a period of time and adjusts the clock timing on the child processor to track the rate of flits received from a parent processor. For a processor in a network of processors, decoupling the clock waveform from the wall clock time allows an arbitrary clock waveform while the compiler still maintains a deterministic knowledge of the wall clock time. This clock timing adjustment enables the software to modulate the clock, thereby managing power and changes in current flow (di/dt). Similarly, decoupling the flit reception rate tracking from the clock waveform of other processors or devices makes it possible to operate a deterministic and/or synchronous system where each processor or device can operate with different clock waveforms for significantly enhanced performance and system configuration flexibility.

Second Element: 2. Changing What You have Control of.

For any processor or other deterministic device, adjustments to the clock period are applied to compensate for drift that occurs as signaled by a difference in the number of flits actually received versus the number expected at compile time. At each measurement period, the difference between the number of flits expected minus the number of flits received is used to adjust the time base of the child processor. In some embodiments, the time base adjustment is performed in a proportional manner.

### Third Element: 3. Structural Stability.

The control loop variable is the difference of the number of expected flits versus the number of actual flits received from the parent by the child for the connectivity arc defined by a minimum spanning tree. This minimal spanning tree is a Directed Acyclic Graph (DAG) which excludes any topological loop in the control process by its inherent structure. With no loops in the spanning tree DAG, network-level control process is inherently stable, meaning network dynamics does not generate oscillations or divergence. On each processor, the Measurement Period and Expected Rate, along with the Proportional and Derivative control loop coefficients, are chosen so as to provide damping sufficient to ensure stability on the chip itself.

### Fourth Element: 4. Rate Initialization Using Global Notify.

The starting point for FRS is a topology-wide Global Notify process in conjunction with all actual and expected packet digital counters being reset to zero by the processors. The C2C links that traverse the spanning tree of the topology are used to perform the topology-wide Global Notify process.

### Fifth Element: 5. Offset Alignment.

The offset associated with the link between any two processor devices is established as a startup calibration operation. As part of the initialization process for the topology, each processor sends a packet out to each neighboring processor. The neighboring processor immediately (or as quickly as possible) returns the packet. The sending processor calculates the Round Trip Time (RTT) by counting the number of chip clock periods that have transpired. Note that the chip clock period should be held to a consistent value during the calibration operation. The One Trip Time delay can be calculated as a function of the Round Trip Time for each link. Route time information is transmitted from each processor to the root processor where the data is consolidated in a single, comprehensive timing graph, where the arcs between processor nodes are annotated as real-time (e.g., nanosecond (ns)) values. Each link delay will be reported by two different processors, and the root will verify these two values for consistency. A significant discrepancy can trigger an exception. The root processor will send the composite timing graph to all processor devices in the topology by transmitting the information throughout the spanning tree. In one ECIN, the RTT information is in a Control and Status Register (CSR) that cannot be read by processor software (SW). The RRT information in the CSR can only be read by a Configurable Computing Unit (CCU) processor. If it is desired to read RTT information into processor Static Random-Access Memory (SRAM), a new process can be added. Alternatively, a process is added to allow the recipient of a packet to immediately (or as quickly as possible) loop it back to the sender, and the sender measuring the difference of the transmit time to the arrival time; an advantage of this process is that the RTT value is immediately available in the processor SW domain.

### Sixth Element: 6. Heuristics.

Consider a set of processors and/or other devices connected in a network graph. A DataFlow SubGraph is a subset of the network graph that activates a subset of processor and a subset of connections between those processors. A Spanning Tree subgraph is a subset of the DataFlow subgraph. The distance between the Spanning Tree root node and the most distant leaf node is the depth of the spanning tree, and this is minimized to reduce the timing difference between leaf nodes. The actual timing difference between any pair of nodes can be measured, and it should always be no greater than a value linearly related to twice the spanning tree depth. To the extent possible, it is preferable (but not mandatory) to use the arcs with the highest expected activity rates in the program DataFlow graph as the preferred arcs used to construct the spanning tree.

### Seventh Element: 7. Flit Counter in Clock Controller.

The FRS/CPS (Clock Period Synthesis) clock controller includes a 14-bit digital counter circuit that tracks the number of flits received by the C2C controller that is configured to operate in the child processor to track the number of flits that are sent by the designated parent processor in the minimum spanning tree. The Clock Controller flit counter is a modulus counter that rolls over to zero when the maximum count is exceeded. The output of this counter is compared to the expected flit count received from an FRS instruction at each measurement point.

These FRS instructions are programmed by the compiler and loaded into instruction SRAM memory for execution during processor program execution. The difference value of the Expected Flit count minus the Actual Flit count is applied to the address input bus of a “FRS Palette” lookup table. The SRAM contents are loaded by a processing architecture, such as a load-store architecture, which can be, for example, an open standard instruction set architecture based on established reduced instruction set computer principles (referred to as an RISC-V). For example, the SRAM contents can be loaded by RISC-V firmware (FW) at boot time and during runtime initialization to enforce upper bounds, lower bounds, and in general the FRS control loop proportional and derivative coefficients. Data output values from the SRAM are transferred to the CPS Finite State Machine (FSM) controller to be used to adjust the clock period up or down to maintain tight alignment of the child program operation relative to the parent program operation. “Tight alignment” refers to an alignment (e.g., matching) that is as close as possible between the child program operation and the parent program operation.

### Eighth Element: 8. Flit Counter in the C2C Receiver Configured to be a Child.

In a multi-processor topology, each processor that is not the root of the spanning tree has exactly one C2C receive link configured to operate as the flit rate monitor for that processor. The root of the minimum spanning tree has no C2C receive link configured to monitor flit rates because the root processor is the reference device for the topology. A 5-bit digital counter circuit in the C2C receive logic is incremented in the flit clock domain as each data packet flit is received. For example, if the data packet size includes 21 flits of 16 bytes each to support 16 bytes of header information and 20 times (e.g., multiplied by) 16 is equal to 320 (e.g., the equation 20*16=320) bytes for the data payload, the 5-bit counter would be incremented 21 times during the receipt of this packet. Similarly, when a NULL data packet of the same size is received, the counter would again be incremented as each of the 21 flits is received. As soon as the flit count FIFO (first in, first out) in the C2C controller is not full, the flit count value is pushed into the FIFO, and the flit count is reset to zero or one if a new flit just arrived during that flit clock cycle. Flits associated with non-data packets, including CSR packets, Fault packets, Idle packets, and Global Notify packets do not affect the flit counter. On every chip clock cycle, the next value is read out of the FIFO in the processor clock domain and transmitted to the FRS/CPS clock controller using a dedicated multi-bit bus. If no value is available from the FIFO, then a zero value will be transmitted. The multi-bit bus should be wide enough to transmit the latest incremental flit count value along with a parity bit for error checking.

### Ninth Element: 9. Flit Support in the C2C Transmitter Configured to be a Parent.

In a multi-processor topology, each processor that is not a leaf node of the spanning tree has one or more C2C transmit links used to send NULL data packets and non-NULL data packets to each child processor. The root of the minimum spanning tree has one or more C2C links configured to be a parent to the respective child processor. A leaf node in the minimum spanning tree may have no C2C links configured to be a parent because leaf nodes have no children by definition, even though they may have any number of data path connections that are not minimum spanning tree arcs.

### Tenth Element: 10. Flit Time Marker Approach.

The parent processor software process transmits a Time Marker Message (TMM) once every Measurement Period (e.g., a real time value, such as, for example 1 microsecond (uS)). The TMM is the highest priority packet and cannot be preempted by a Fault or CSR packet. The TMM contains a 16-bit value, referred to as a Parent Offset, that is the offset from the desired ideal, in units of the child's High Frequency Clock Phase Period (HFCPP), programmed in the instruction stream by the compiler. Idle flits may be inserted at a media-independent interface (e.g., a 10-gigabit media-independent interface (XGMII)) to precisely position the TMM at the designated flit position. If the Forward Error Correction (FEC) frame boundary information is knowable, the TMM should be programmed to be inserted at a consistent position in the FEC frame to minimize Transmit (Tx) and Receive (Rx) PCS jitter. When the child receives a TMM message, it immediately sends the 16-bit value out using a dedicated ring bus that connects all C2C modules to the FRS/CPS controller.

The FRS controller has a CSR register that contains the Measurement Period in units of HFCPP. A counter in the FRS is initialized to the MP value upon receipt of a Global Notify. The FRS controller has a circular buffer implemented as a 256 word register file with one read port and one independent write port. The circular buffer word width is 9 bits and on each clock cycle, the CPS period is written into the circular buffer using the write port with the Head address (modulo 256). When the FRS controller receives the TMM, it records the value of Head in a register called TcyTmm. There is a CSR register called Latency that holds the number of clock cycles it takes to propagate the TMM from the C2C that received the message from the parent. The FRS counter is decremented by the value of each clock period, and when it becomes negative, the value of Head is stored in TcyRef, and the residual value in the counter is stored in a register called Child Offset. The counter is set to Measurement Period+Child Offset (a negative number)−the CPS clock period for this cycle. The Read Address is set to the earliest of (TcyRef, TcyTmm) and steps through each location accumulating the CPS period values up to the latest of (TcyRef, TcyTmm) to calculate the Cycle Delta. The Adjusted Delta is computed as Cycle Delta-Parent Offset-Child Offset. The Adjusted Delta, a 16-bit value in units of HFCPP, is used as the address input to an SRAM Look Up Table (LUT) to produce an 8-bit value that is supplied to the CPS controller to shorten or lengthen the next few clock periods, as necessary.

Each child processor uses a process to track the frequency of the parent it is connected to. This establishes a transitive relationship to the minimum spanning tree (MST) root which serves as the global frequency reverence. Adjustments to each child processor should be small changes to dampen any jitter inherited from the chain of ancestors from the parent to the root, and also the additional jitter introduced by the non-deterministic clock domain crossings and SerDes operations. For reference, a maximum drift of 50 ppm would require an adjustment of 27.78 picosecond (pS) once every 555.56 nanosecond (nS). In practice, the SRAM LUT would likely be programmed to ignore small Adjusted Delta values to avoid reacting to jitter noise. This noise-filtering dead zone will allow a parent-child phase offset to manifest.

In each parent, the easiest approach is for the compiler to schedule the beacon using ISA instructions because the compiler knows all of the CPS instructions on the parent and the child, and the timing of data packets that need to be sent from the parent, so there is no non-deterministic alignment challenge. However, this requires each C2C link configured to be a parent to execute a continuous sequence of instructions, only some of which may be repeatable procedures.

An alternative that does not require any ongoing ICU instructions is to implement an SRAM table in each C2C transmitter, where the table is populated before the program starts using CSR or ISA instructions. The table specifies the number of clock cycles until the next Measurement Period, calculated by the compiler by taking into account the CPS instructions on the parent and the child during the previous Measurement Periods. The table indicates when the next Measurement Period is due, there is a potential conflict with a SW initiated data packet, so a HW offset would need to be calculated based on the timing of the packet header that was actually set for the beacon vs the desired timing, where the request is always sent earlier than the worst possible data packet delay, and then the delay is sent to the child in child time units which will in practice be difficult to compensate for differential parent/child CPS clock periods.

### Expected Number of Flits Per Measurement Period

The Expected Number of Flits and the Measurement Period duration values are set by software compiled for each processor. As each Measurement Period expires, a cumulative count will be accumulated. The Measurement Period value and the Expected Number of Flits are reused for subsequent Measurement Periods until the software updates these values. Accumulator and counter values for the expected and actual number of flits received are set to zero at the time of a Global Notify event. An alternative interface is for the processor SW to simply set the expected value periodically, where the instruction that sets the expected value trigger a measurement sequence; this alternative requires ongoing attention from the SW that the first method relaxes.

### Packets vs Flits

Packets are an efficient data structure for data exchange rate between communicating processor devices. However tracking the FLIT (FLow control unIT) count, instead of packets, has several advantages including 20 times finer resolution for data packets that have a 320-byte vector data payload in 20 flits. Whether packets or flits are tracked, the rate of reception of either item may still be bursty when the data flow pattern is irregular.

### Dedicated Bus for Flit Rate Information

A dedicated asynchronous serial bus can be used to communicate the expected versus actual flit reception rate information to the clock controller using one or more electrical or optical connections dedicated to this purpose. Each bus can daisy chain multiple C2C ports along the path from the farthest C2C to the clock controller. In an ECIN, only one C2C link will send rate information to the clock controller; if the FRS interface is generalized to allow multiple tracking links, then bus contention arbitration is necessary. There may be more than one serial bus; for example there may be one bus for C2C ports on the north edge of the processor, one for the southwest edge, and one for the southeast edge. The clock controller should manage all of the serial buses. The number of connections in the communication bus may be one or more to reduce the latency from a measurement period until the control loop processes the data; for example, the bus could be two, four, or eight wires wide. The asynchronous protocol begins with a start code word. In the preferred ECIN, the payload of the message includes the difference of the expected minus the actual flits received since the last Global Notify event; an alternative ECIN may send the two total values to the clock controller for more extensive processing. The ID number of the C2C port sending the rate information message should be included with the message, and the message will also contain a 16-bit Cyclic Redundance Check (CRC) of all data fields in the message (excluding the 16-bit CRC value itself), calculated using the polynomial 0xA2EB in “normal form” with an initialization value of 0x0000.

### CSR Ring

The CSR Ring can be used as an alternative to the dedicated serial bus to communicate rate information from C2C ports to the clock controller. The CSR Ring method may impose a very long latency to obtain the rate difference information to the clock controller, which may be a disadvantage relative to the dedicated serial bus.

### Modulus Counter

A modulus counter that is ten bits or larger is used to track the actual number of flits received, as implemented in the preferred ECIN of the C2C controller. The Actual Flits Received counter is reset to zero at the time of a Global Notify event, and is incremented by one as each flit is received to track the actual number of flits. An alternative ECIN is to have the C2C controller export the clock that signals the reception of a flit, and the logic (e.g., Groq logic) associated with that C2C port implements the ten-bit counter. If a flit Rx clock is not possible for some reason, then a clock that signals when each packet is received may be used with a twenty times (20×) loss of precision.

As each Measurement Period expires, the expected flit reception count is accumulated in a counter that is the same size as the counter that tracks the actual number of flits received. The latest flits received counter value are transferred from the flit clock domain to the chip clock domain with the shortest possible latency to avoid offset error. In an ECIN, the expected minus actual rate difference is calculated by the C2C port logic (e.g., processor logic) block. The difference calculation must accommodate the modulus behavior of both counter values.

### Clock Controller Uses Rate Difference Information

The clock controller uses the rate difference information to make incremental adjustments to the clock timing of the processor device under consideration. In an ECIN, adjustment amounts are applied to one or more designated clock periods, where the affected clock period is lengthened or shortened by one High Frequency Clock Phase Period (e.g., 27 pS for CPS using an 18 GHz Phase-Locked Loop (PLL) clock). The total magnitude of the adjustment is proportional to the rate difference as set by a Proportional Coefficient, and may be capped or limited by an upper bound referred to as the Derivative Coefficient; the clock controller behaves like a simple Proportional Derivative (PD) algorithm controller.

### CCU RISC-V Processor

The CCU RISC-V processor also has access to the rate difference information, and can be used by a FW defined algorithm to implement a more sophisticated control loop algorithm such as a Proportional-Integral-Derivative (PID) controller. In an ECIN such as this, the RISC-V processor would communicate the necessary adjustment value to the clock controller.

### Processor Software (SW) Sets Status Bits in CPS Instruction Field

Processor SW sets status bits in the CPS instruction field (reference the instruction word format in the CPS specification) to indicate clock periods that are acceptable or preferred for the application of an adjustment amount. Note that a sufficient number of ‘Shortenable’ and ‘Lengthenable’ clock periods are necessary for the FRS control loop to track effectively.

Shortenable-tag for clock periods that are suitable for shortening. Note that in some programs there may be long sequences of instructions that are running with the shortest period per cycle that is sustained by the STA closure on the critical paths at the operating Vdd and temperature. In such cases, the compiler should insert a shortenable CPS instruction at a time where it can be optionally employed after a C2C measurement operation has been performed. A suitable Shortenable clock period is one where the addition or subtraction of one HFCPP tick would not exceed the minimum or maximum period value programmed in the CPS controller.

Lengthenable-tag for clock periods that are suitable for lengthening. Note that it is almost always true that it is OK to lengthen an instruction cycle because the timing is always safe for a longer period cycle, and the power would be lower. Therefore, in practice, setting this false on certain cycles such as low energy cycles would effectively bias toward the use of the higher energy cycles where there would be a slightly larger fortuitous (or serendipitous) side-effect.

### Alternative FRS Considerations

In one ECIN, the CPS clock period controller includes a Measurement Table SRAM that includes a memory with 8Ki words of 40 bits each, where each word has a 20-bit Measurement Period, 19-bit Expected Flit Increment, and one bit to designate multiple iterations; if the multiple iterations bit is set. The subsequent word in the memory can contain the number of additional iterations after the first iteration, otherwise the subsequent word in memory contains the next Measurement Period and Flit Increment. The Measurement Table SRAM can be programmed by the runtime software using values that were determined by the Compiler. There can also be a seven-bit register that is programmed by the runtime software with the ID number of the C2C link to the minimum spanning tree parent of the child processor under consideration. If the processor under consideration is the root of the spanning tree, then the ID register will be programmed with the value 0x7F. The CPS controller resets the Measurement Period Counter to the first Measurement Period value when a Global Notify command is received. The Measurement Period Counter then decrements once for each Chip Clock period until it has the value zero. Upon or after the value zero is reached, a message is sent on the FRS Serial Bus which is a ring that daisy chains all C2C ports in a single loop. The message contains the ID number of the C2C link connected to the minimum spanning tree parent, and the message also contains a CRC16 value. When a C2C port receives a message with a matching ID number and a valid CRC checksum, the C2C port responds by sending a message on the FRS Serial Bus back to the CPS controller, using the ID number 0x7E. In addition to the ID number, the message can contain the 10-bit value representing the Actual Flit Count, modulus 2\hat{ }10.

### BRS Theory of Operation

The basic approach for a hardware-only C2C Beacon Rate Synchronization (BRS) method is to intermittently apply a small adjustment to certain clock periods on the child processor in order to maintain a constant distance (phase) between arrival times of a periodic time beacon sent by the parent processor.

### 1. Minimum Spanning Tree Root Processor

A set of processor devices configured in a network topology has a minimum spanning tree (MST) configured during a setup operation by defining parent-child relationships. There is a single root device in the MST that has no parent and has one or more children. Other than the root, all other processor devices in the MST have exactly one parent and zero or more children. Leaf nodes in the MST have one parent and zero children. It is preferred, but not mandatory, to configure the MST to be as shallow as possible to minimize the variance in the links that results in timing jitter due to FEC block alignment, clock domain crossings (CDC), vibration, thermal effects, etc. The essential property is that the MST is a Directed Acyclic Graph (DAG) to avoid network-level instabilities.

### 2. Root Time Beacon Signal Origination

In the BRS/CPS clock controller on a singular processor configured to be the MST root, the HW FSM will emit a Time Beacon Signal (TBS) at a period defined by a CSR register value called the Time Beacon Period (TBP). The TBP is defined in units of the short CPS interval called a HFCPP, or equivalent for other clocking mechanisms. For example, when CPS is configured using a 18 GHz PLL, the HFCPP has a 27.78 pS duration, and a TBP might be set to 36,000 HFCPP periods for a beacon emitted every 1 uS. A 32-bit Virtual Time Clock (VTC) in the BRS/CPS module is initialized to the TBP value at power up or using a CSR instruction. During each cycle of the chip clock, the VTC value is decremented by the duration of the chip clock period in units of HFCPP. When the VTC value becomes negative, the next Time Beacon Signal is emitted, and the VTC value is set to the TBP minus the current chip clock period remainder. The TBS is sent out to a Time Beacon Ring (TBR) that connects to every C2C module on the processor device. The BRS/CPS clock controller ignores and discards the TBS that returns via the TBR back to the controller.

### 3. C2C Tx Link Configured to be a Parent

The Time Beacon Signal sent by the BRS/CPS clock controller on the Time Beacon Ring bus provides a periodic signal to any C2C Tx link that is configured via CSR to be a parent to a neighboring processor child. When the TBS is received by the C2C controller, a special Time Beacon Flit (TBF) is sent with a special header flag that distinguishes this unique flit type. To minimize overhead, the TBF should be limited to a single flit, or the smallest number of flits possible for the available C2C controller. The TBF will be inserted into the SerDes Tx data stream at the earliest possible opportunity. Similarly, when a C2C configured to be a parent receives a TBN from a C2C configured to be a child, the same (or a similar) TBF Tx action is executed.

### 4. C2C Rx Link Configured to be a Child

Any C2C Rx link that is configured via CSR to be a child to a neighboring processor parent will periodically receive a TBF. When each TBF is received, the child C2C controller will emit a Time Beacon Notification (TBN) onto the TBR bus. The C2C controller that emitted the TBN ignores and discards the TBN that returns via the TBR back to the C2C after one cycle around the ring. When the TBN is received by a C2C link configured to function as a parent, that C2C link will immediately execute a TBF Tx action. When the TBN is received by the BRS/CPS clock controller, a clock period alignment adjustment will be executed.

### 5. Time Beacon Clock Alignment

When the BRS/CPS clock controller on any device that is not configured to be the MST root receives a Time Beacon Notification (TBN) from the Time Beacon Ring (TBR) bus, it will use this notification signal to make an adjustment to the processor clock to compensate for relative drift between the child processor and the MST root reference rate. The BRS/CPS clock controller on a child processor includes a 32-bit Virtual Time Clock (VTC) that is initialized to the Time Beacon Period (TBP) value at power up or using a CSR instruction. During each cycle of the chip clock, the VTC value is decremented by the duration of the chip clock period in units of HFCPP. The VTC value is not affected by units of HFCPP that are injected to align the child rate to the MST root rate. When the VTC value becomes negative, the next local time adjustment operation is initiated, and the VTC is set to the TBP minus the current chip clock period remainder. The difference between the TBP and the VTC is computed to determine the relative position of the child clock rate to the MST root reference rate. The difference value is applied to the address bus of a Beacon Palette SRAM used as a look-up table to set upper and lower bounds and the proportional and derivative control loop coefficients. The output of the LUT is provided to the CPS controller which will shorten or lengthen the period of an appropriate number of clocks to adjust the child clock as required.

### 6. Time Beacon Ring Message Types

There are three message types communicated using the Time Beacon Ring (TBR) bus: enum {NULL=0, TBS=1, TBN=2}. Therefore, a three-wire ring bus is utilized with two data wires and one odd parity wire to protect against noise or signal corruption. Messages received from the TBR bus should be ignored if the parity of the message is not odd.

### 7. Jitter Budget

The jitter between Time Beacon Notifications received on different processor devices is bounded by the following equation, where the use of the KP4-RS (544,514) FEC algorithm and a nominal clock period of InS is assumed:

1(root clock period alignment)+2*MST Depth*(5440/112+2(CDC crossings)

For a MST Depth of 4, the jitter bound is 405.57 nS (e.g., jitter on each processor is +/−202.79 nS).

There is also exposure to additional variance due to the cumulative difference in the sum of the clock cycles required to pass messages on the TBR to and from C2C controllers, and with additional HW support in each C2C, this variance may be mitigated.

One possible mitigation to the FEC block size alignment uncertainty is to align each child only to its parent. By doing this, the connection to the root reference would be transitive, complicating the stability dynamics and significantly increasing the amount of information to be exchanged between the BRS/CPS controller and the C2C.

### RCS Theory of Operation

The basic approach for the HW-only C2C Reference Clock Synchronization (RCS) method is to align the effective frequency of the Reference Clock on the Child to the effective frequency of the Reference Clock on the MST root. After power-up, an initialization command is sent to the RCS controller to capture the initial phase offset. The HW then seeks to maintain this constant phase offset over time by applying small adjustments to certain clock periods on the child device.

### 1. Minimum Spanning Tree Root Processor

A set of processor devices configured in network topology has a minimum spanning tree (MST) configured during a setup operation by defining parent-child relationships. There is a single root device in the MST that has no parent and has one or more children. Other than the root, all other processor devices in the MST have exactly one parent and zero or more children. Leaf nodes in the MST have one parent and zero children. It is heuristically preferred, but not mandatory, to configure the MST to be as shallow as possible to minimize the variance in the links that results in timing jitter due to FEC block alignment, clock domain crossings (CDC), vibration, thermal effects, etc. The essential property is that the MST is a Directed Acyclic Graph (DAG) to avoid network-level instabilities.

### 2. Root Reference Clock Signal Origination

In the RCS/CPS clock controller on the singular device configured to be the MST root, the chip PLL Reference Clock input will be used to derive a Time Beacon Signal (TBS) that is emitted at a period defined by a CSR register value called the Reference Period Multiplier (RPM). The real time period of the TBS is the Reference Clock Period times the Reference Period Multiplier. For example, when the root processor is configured using a 100 MHz Reference Clock with a RPM of 100, the TBS period will be 1000 nS. The TBS emitted by the RCS/CPS controller is directly propagated to every C2C module on the processor device.

### 3. C2C Tx Link Configured to be a Parent

The Time Beacon Signal sent by the RCS/CPS clock controller provides a periodic signal to any C2C Tx link on the root processor that is configured via CSR to be a parent to a neighboring processor child device. When the TBS is received by a parent C2C controller on the root processor, a special Time Beacon Flag (TBF) is sent as a header flag that distinguishes this unique event. To minimize variance, the TBF should be reflected in the header of the next packet sent, whatever the type of packet. To the extent possible, any delay in the timing of the TBF due to packet queueing should be compensated. The TBF should be inserted into the SerDes Tx data stream at the earliest possible opportunity. Similarly, when a C2C configured to be a parent receives a TBN from a C2C configured to be a child, the same TBF Tx action is executed.

### 4. C2C Rx Link Configured to be a Child

Any C2C Rx link that is configured via CSR to be a child to a neighboring processor parent device will periodically receive a TBF. When each TBF is received, the child C2C controller will emit a Time Beacon Notification (TBN) onto the TBR bus. The C2C controller that emitted the TBN ignores and discards the TBN that returns via the TBR back to the C2C after one cycle around the ring. When the TBN is received by a C2C link configured to function as a parent, that C2C link will immediately execute a TBF Tx action. When the TBN is received by the BRS/CPS clock controller, a clock period alignment adjustment will be executed.

### 5. Time Beacon Clock Alignment

When the BRS/CPS clock controller on any device that is not configured to be the MST root receives a Time Beacon Notification (TBN) from the Time Beacon Ring (TBR) bus, it will use this notification signal to make an adjustment to the processor clock to compensate for relative drift between the child processor and the MST root reference rate. The BRS/CPS clock controller on a child processor includes a 32-bit Virtual Time Clock (VTC) that is initialized to the Time Beacon Period (TBP) value at power up or using a CSR instruction. During each cycle of the chip clock, the VTC value is decremented by the duration of the chip clock period in units of HFCPP. The VTC value is not affected by units of HFCPP that are injected to align the child rate to the MST root rate. When the VTC value becomes negative, the next local time adjustment operation is initiated, and the VTC is set to the TBP minus the current chip clock period remainder. The difference between the TBP and the VTC is computed to determine the relative position of the child clock rate to the MST root reference rate. The difference value is applied to the address bus of a Beacon Palette SRAM used as a look-up table to set upper and lower bounds and the proportional and derivative control loop coefficients. The output of the LUT is provided to the CPS controller which will shorten or lengthen the period of an appropriate number of clocks to adjust the child clock as required.

### 6. Time Beacon Ring Message Types

There are three message types communicated using the Time Beacon Ring (TBR) bus:
enum {NULL=0, TBS=1, TBN=2}

Therefore, a three-wire ring bus is utilized with two data wires and one odd parity wire to protect against noise or signal corruption. Messages received from the TBR bus should be ignored if the parity of the message is not odd.

### 7. Jitter Budget

The jitter between Time Beacon Notifications received on different processor devices is bounded by the following equation, where the use of the KP4-RS (544,514) FEC algorithm and a nominal clock period of InS is assumed:

1(root clock period alignment)+2*MST Depth*(5440/112+2(CDC crossings))

For a MST Depth of 4, the jitter bound is 405.57 nS (e.g., jitter on each processor is +/−202.79 nS).

There is also exposure to additional variance due to the cumulative difference in the sum of the clock cycles required to pass messages on the TBR to and from C2C controllers, and with additional HW support in each C2C, this variance may be possible to mitigate.

One possible mitigation to the FEC block size alignment uncertainty is to align each child only to its parent, so that the connection to the root reference would be transitive, complicating the stability dynamics and significantly increasing the amount of information to be exchanged between the BRS/CPS controller and the C2C.

### CPS-RT Theory of Operation

The basic approach for hardware-only Clock Period Synthesis-Rate Tracking (CPS-RT) method is to align the effective frequency of the processor clock on the child to track any relative drift with respect to the processor clock on the MST root. After power-up, each processor that is not configured to be the MST root self-initializes after receiving ten signals from the MST root. The hardware then seeks to maintain a nearly zero difference in the count of expected signals to actual MST root originated signals by periodically applying small adjustments to certain clock periods on the child processor.

The MST root sends a periodic signal as often as possible, but not so often that a backlog of the signals pile up. For example, at 100 GbE rates, each 320-Byte payload packet of 21 flits takes 21*1.28 nS=26.88 nS, so a signal separation larger than that is recommended. One signal every 50 nS or 100 nS would be a reasonable rate. When a child C2C receives the time synchronization signal, it sends a one-bit message on a ring bus that is observed by every C2C and the CPS controller. When the message completes the loop and returns to the originating C2C, the propagation of the message is terminated. Any C2C that is configured to serve as a parent forwards the signal in the next available packet header.

An advantage of this approach is that it is substantially immune to latency and tolerant of substantial latency variance (within limits, of course) for the propagation path of the periodic reference rate signal from the root of the MST to each processor in the MST. Initial synchronization is easily accomplished by zeroing the expected and actual counts, and this can be done unilaterally at power-up or as a fault mitigation any time the divergence in the expected-actual counts exceeds some boundary value. Another tactical advantage is that all arithmetic is done in the low frequency chip clock domain for the calculation of the child's expected value, and this same low-frequency logic can be reused by the MST root to generate the global reference signal. Similarly, communication between C2C and CPS units is accomplished using a single-bit ring, with pipeline registers operating in the chip clock domain.

A truncated Taylor series formed by a generalized fourth-degree polynomial is used to transform any local reference clock period to the magnitude of the global time reference period. For example, if the half-cycle VCO output is 31.415936 pS and the expected rate of MST root signals is one every 100 nS, then the expected counter is incremented by one after 100 nS/31.415926=3183 HFCPP ticks. The accumulated count of target period amounts is adjusted by a small positive or negative value after some number of cycles. In this example, each time 10 of the 100 nS pulses are tallied, an extra one tick is added to the accumulated value, and each time 100 of the 100 nS pulses are tallied, no extra value is added, and each time 1000 of the 100 nS pulses are tallied one is subtracted from the accumulated value.

The Chip-to-Chip communication interface is a SERDES-based interface that utilizes custom logic to enable high-speed communication between devices. The interface is designed to operate solely in hardware, without the need for software instructions, and all configuration is done at boot time or between programs via CSRs. The interface is capable of automatically adding a child to an existing MST or recovering from a major synchronization disruption. All logic operates in the chip clock domain, making it relatively insensitive to transmission delay and variance. The granularity of the reference signals is on the order of somewhat less than 50 nanoseconds, and the child phase adjustment target can be recalculated after every reference signal. The maximum change to any individual clock cycle is one HFCPP, and the rate tracking mechanism is agnostic to software program alignment initialization. The interface uses a Taylor Series Polynomial to match rates for any combination of PLL VCO frequencies and features a programmable dead zone to keep jitter low. The hardware overhead is a one-wire ring that circumnavigates the chip, plus a few thousand gates of logic in the CPS controller, and the hardware overhead in SerDes is only to set a one-bit flag in the next Tx packet and to recognize the Rx flag.

The interface also features a metastable 2 chip clock periods delay, which is subtracted out using a pipeline, and then the accumulation sequence begins until the RefClk rising edge after the metastable 2 chip clock periods delay, subtracted out using a pipeline. This gives the difference and polarity. The RefClk countdown is propagated to parents or child Rx beacon flit, delayed by designated N flit times, and then propagated to parents, with an offset of 32, subtracting the flit position in the Tx queue and storing the net offset in the beacon flit header. The Tx flit clock and Rx flit clock are obtained from the SerDes or generated using a 5×PLL multiplier of the 156.25 ref once on the north edge and once on the south edge, or once per chip. The root RefClk is divided by the BeaconCount and propagated to the parent C2C Tx, with the flit offset set to 32, subtracting the position and setting the header to the beacon with the offset value. The child Rx flit header time is delayed by the offset number of flits and propagated to parents and the CPS Ctrl. The CPS HFCPP counter window opens with a pipeline delay of two chip clock periods, and the first signal starts the accumulation sequence and sets the polarity. If the window closes, the measurement is abandoned, otherwise the second signal stops the accumulation sequence. The difference is input to an SRAM LUT with 16 address bits in and 16 data bits out, and the data output value and polarity are sent to the CPS controller to be applied to adjustable periods.

### 1. Minimum Spanning Tree Root Processor

A set of processor devices configured in network topology has a minimum spanning tree (MST) configured during a setup operation by defining parent-child relationships. There is a single root device in the MST that has no parent and has one or more children. Other than the root, all other processor devices in the MST have exactly one parent and zero or more children. Leaf nodes in the MST have one parent and zero children. It is heuristically preferred, but not mandatory, to configure the MST to be as shallow as possible to minimize the variance in the links that results in timing jitter due to FEC block alignment, clock domain crossings (CDC), vibration, thermal effects, etc. The essential property is that the MST is a Directed Acyclic Graph (DAG) to avoid network-level instabilities.

### 2. Root Reference Clock Signal Origination

In the RCS/CPS clock controller on the singular device configured to be the MST root, the chip PLL Reference Clock input will be used to derive a Time Beacon Signal (TBS) that is emitted at a period defined by a CSR register value referred to as the Reference Period Multiplier (RPM). The real time period of the TBS is the Reference Clock Period times the Reference Period Multiplier. For example, when the root processor is configured using a 100 MHz Reference Clock with a RPM of 100, the TBS period will be 1000 nS. The TBS emitted by the RCS/CPS controller is directly propagated to every C2C module on the processor device.

### 3. C2C Tx Link Configured to be a Parent

The Time Beacon Signal sent by the RCS/CPS clock controller provides a periodic signal to any C2C Tx link on the root processor that is configured via CSR to be a parent to a neighboring processor child device. When the TBS is received by a parent C2C controller on the root processor, a special Time Beacon Flag (TBF) is sent as a header flag that distinguishes this unique event. To minimize variance, the TBF should be reflected in the header of the next packet sent, whatever the type of packet. To the extent possible, any delay in the timing of the TBF due to packet queueing should be compensated. The TBF should be inserted into the SerDes Tx data stream at the earliest possible opportunity. Similarly, when a C2C configured to be a parent receives a TBN from a C2C configured to be a child, the same TBF Tx action is executed.

### 4. C2C Rx Link Configured to be a Child

Any C2C Rx link that is configured via CSR to be a child to a neighboring processor parent device will periodically receive a TBF. When each TBF is received, the child C2C controller will emit a Time Beacon Notification (TBN) onto the TBR bus. The C2C controller that emitted the TBN ignores and discards the TBN that returns via the TBR back to the C2C after one cycle around the ring. When the TBN is received by a C2C link configured to function as a parent, that C2C link will immediately execute a TBF Tx action. When the TBN is received by the BRS/CPS clock controller, a clock period alignment adjustment will be executed.

### 5. Time Beacon Clock Alignment

When the BRS/CPS clock controller on any device that is not configured to be the MST root receives a Time Beacon Notification (TBN) from the Time Beacon Ring (TBR) bus, it will use this notification signal to make an adjustment to the processor clock to compensate for relative drift between the child processor and the MST root reference rate. The BRS/CPS clock controller on a child processor includes a 32-bit Virtual Time Clock (VTC) that is initialized to the Time Beacon Period (TBP) value at power up or using a CSR instruction. During each cycle of the chip clock, the VTC value is decremented by the duration of the chip clock period in units of HFCPP. The VTC value is not affected by units of HFCPP that are injected to align the child rate to the MST root rate. When the VTC value becomes negative, the next local time adjustment operation is initiated, and the VTC is set to the TBP minus the current chip clock period remainder. The difference between the TBP and the VTC is computed to determine the relative position of the child clock rate to the MST root reference rate. The difference value is applied to the address bus of a Beacon Palette SRAM used as a look-up table to set upper and lower bounds and the proportional and derivative control loop coefficients. The output of the LUT is provided to the CPS controller which will shorten or lengthen the period of an appropriate number of clocks to adjust the child clock, as necessary.

### 6. Time Beacon Ring Message Types

There are three message types communicated using the Time Beacon Ring (TBR) bus:
enum {NULL=0, TBS=1, TBN=2}
so a three-wire ring bus is required with two data wires and one odd parity wire to protect against noise or signal corruption. Messages received from the TBR bus should be ignored if the parity of the message is not odd.

### 7. Jitter Budget

The jitter between Time Beacon Notifications received on different processor devices is bounded by the following equation, where the use of the KP4-RS (544,514) FEC algorithm and a nominal clock period of InS is assumed:

1(root clock period alignment)+2*MST Depth*(5440/112+2(CDC crossings))

For a MST Depth of 4, the jitter bound is 405.57 nS (e.g., jitter on each processor is +/−202.79 nS).

There is also exposure to additional variance due to the cumulative difference in the sum of the clock cycles required to pass messages on the TBR to and from C2C controllers, and with additional HW support in each C2C, this variance may be possible to mitigate.

One possible mitigation to the FEC block size alignment uncertainty is to align each child only to its parent, so that the connection to the root reference would be transitive, complicating the stability dynamics and significantly increasing the amount of information to be exchanged between the BRS/CPS controller and the C2C.

### Global Synchronized Time (GST)

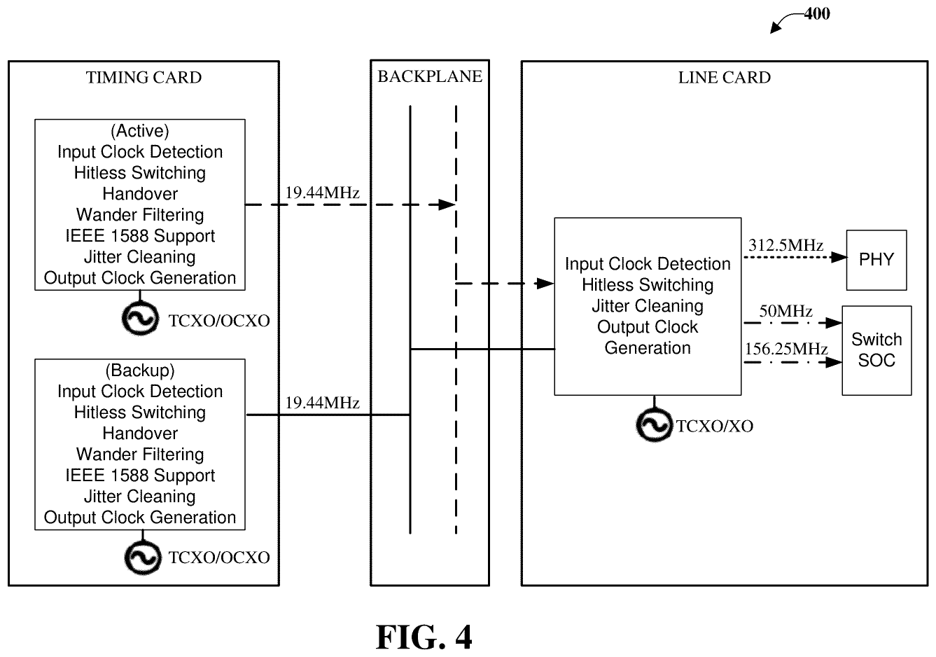

Refer now to FIG. 4. This method uses a DAG (preferably a shallow tree) of Digital PLL based network synchronizers to propagate a mesochronous time reference to every processor and FPGA in the network. In a distributed system, timing synchronization and compensation are crucial for ensuring reliable communication between processor nodes. In this system, each (tensor) processor operates at a different frequency at different times, with a common fast PLL clock (e.g., 10 GHZ). To achieve synchronization, all processors are configured as a spanning tree, with each parent processor generating a beacon pulse to a downstream C2C interface at a constant rate (e.g., 1 us or 10,000 PLL clocks @ 10 GHZ).

The path between the parent processor and the C2C interface has a constant delay, and the wire delay between the parent and child processors is also constant. The child processor expects a beacon at a constant rate, with some jitter. If the child processor receives a beacon early or late, it means its PLL clock is running slower or faster, respectively, compared to its parent, and adjusts its PLL clock accordingly to maintain synchronization.

To compensate for timing mismatches, the root processor transmits beacons at a fixed PLL clock count interval (e.g., 10,000 PLL clocks). Each child processor transmits a beacon to its children only after receiving a beacon from the root processor, ensuring that all processors are synchronized to the root. When a child processor receives a beacon, it checks the delta between the arrival count and the expected count. If the delta is positive, the child processor slows down its subsequent processor clocks by the corresponding number of PLL clocks. If the delta is negative, the child processor speeds up its processor clocks by reducing the clock width.

To reduce jitter in the C2C interface, a delay timer in the beacon clock domain starts incrementing as soon as a beacon is received in the C2C interface. The delay value is then sent to the CPS, which converts it to the PLL clock domain and adjusts the arrival time of the beacon accordingly. The effective arrival time is then compared to the expected arrival time before tuning the processor clock. In the event of a dropped beacon, the system employs a 4-bit cyclic redundancy check (CRC) to ensure the legitimacy of the beacon. Any illegitimate beacon is dropped, and the expected counting continues. If a subsequent beacon is received and the expected count is greater than 1.5 times the set interval, it is assumed that a beacon is lost. If more than two beacons are lost in a row, it is assumed that the parent processor is down, and a fault is asserted, requiring a system reset or checkpoint restart.

In one ECIN, a system provides a stream programming model to the programmer and compiler designer. This producer-consumer programming model uses streams to communicate efficiently between functional units on the same chip or among different chips. The instruction set architecture (ISA) supports fine-grain communication between processors for efficiently transferring relatively short messages—320 bytes each—between a pair of processors. Each pair of processors cooperate with an orchestrated Send (v) on the transmitter, and Receive (v) on the receiver, once the in-flight vector is guaranteed to have arrived, after T cycles.

In one ECIN, an oven-stabilized/temperature-compensated crystal oscillator generates a relatively low frequency reference signal (e.g., 16 MHz) which fans out to multiple CAT5 (or CAT5e, CAT6, or even CAT3) ports on a 48-port (or 24, 72, or 96) 2U rackmount patch panel using differential PHY signal drivers. For longer distances, fiber cable could also be used if the distance between racks in a datacenter exceeds the usable distance that the 16 MHz signal can propagate over CAT6 cable. These timing cards can be configured in a shallow tree to support thousands of processor chassis. Each chassis fans out the mesochronous clock reference to every processor and FPGA in the node. A network synchronizer device such as the Ti LMK05318 DPLL is used for the reference oscillator and each receiver. The PLL is programmed to track with a very low bandwidth (e.g., a few kHz) to provide strong noise immunity.

With this mesochronous clock reference method, the entire network has a single common global time reference, so there is zero relative drift between devices. There is no expectation of phase relationship for derived clocks that may operate at GHz rates, the only guarantee is zero relative drift.

In addition to a single master timing reference card and possibly some spare cards, each child timing card can serve a cluster of six racks, so the total number of timing cards required for a large topology is small.

Since the CAT5 cable has four differential pairs and only one pair is required for the timing reference signal, the other pairs could be used for control plane signaling. For example, if a node suffers a catastrophic failure or any exception that disrupts normal communication with the host system, the available differential pairs could be used to communicate the exception condition to a central host.

### Global Time Synchronization Without Coax

An alternative ECIN to universal synchronization is described below as a combination of the best properties of GTS and the elimination of the need for a separate coax cable network by using CPS-RT concepts to encode the synchronizing reference signal in the header of every network traffic packet

Global Time Synchronization Without Coax is essentially a definition by negation. The emphasis is on eliminating the need for a separate coax wiring network to transmit the synchronization signal. For a patent application the title “Recovered Clock Drift Elimination” is recommended instead. (Other possible variants include Drift Elimination Using Recovered Clock, GTS Using Recovered Clock, GTS Using Recovered Beacon, or GTS Using Recovered Clock Beacon.)

An external reference clock is required to encompass all of the deterministic processing elements in a system, including processor and FPGA devices. Two key differences between these solutions include the use of an internal vs external source for the Time Beacon Notification, and the use of an internal vs external DPLL for reference clock tracking. An overview of these alternatives is presented here.

A. Use an external, separate coax cable network to disseminate a nominally 50 MHz synchronization signal that is phase locked by a digital PLL in a network synchronizer chip on each system, to create a local reference clock used by all processor and FPGA chips in that system, eliminating all relative long-term drift among all participating processors. This is the technique called Global Synchronized Time (GST) that is described in detail in a separate section below.

B. Use an internal flag bit in the header of appropriate C2C packets transmitted across the MST from root to leaf node generally, or from parent to children specifically to propagate the Time Beacon Signal (TBS). The preferred lowest-latency, lowest-jitter mechanism is to use a dedicated bit in the header of all or most packet formats. If a header bit is unavailable, then a separate packet can be used explicitly to send the TBS, but this introduces the need for undesirable arbitration when the packet is inserted in the data stream, and potentially more jitter if it is necessary to wait for one or more high-priority packets to be transferred before the TBS packet can be sent. The internal TBS approach is explained further as part of the CPS Rate Tracking (CPS-RT) mechanism that is described in detail in a separate section below. The internal TBS signal can be used either to drive an internal DPLL as summarized in the next paragraph (B1), or it can be exported to an external DPLL as summarized in the following paragraph (B2) below.

B1. The Time Beacon signal is used to phase lock an integrated DPLL affiliated with CPS where the CPS shorten and lengthen abilities are used to adjust selected clock waveforms in coordination with adjustments made to a virtual 50 MHz tracking signal to effectively compensate for drift on the actual reference clock. The same circuit would need to be replicated on all processor chips (e.g., Polaris and beyond) and also on all FPGA chips.

B2. The Time Beacon signal is sent out on a GPIO pin and used as the input to the blade or chassis level external network synchronizer chip. The TBS is nominally a pulse that is one ChipClock period in duration, which may be difficult to reliably emit on a relatively slower GPIO pin, so the TBS signal may be conditioned to be more compatible with GPIO bandwidth limitations. For example, the TBS duty cycle may be extended by the equivalent of a one-shot monostable multivibrator, possibly implemented by a counter; in one implementation the TBS signal may trigger a counter that counts out something such as, for example, 1000 ChipClock cycles for a 1 uS long pulse assuming the ChipClock is about InS nominally. An alternative implementation would be to have the TBS toggle a flip-flop so that the signal output on the GPIO pin would be at half the frequency of the TBS. Both edges would still be visible externally, so the timing of each pulse could be recovered if desired.

The MkBeacon module in the MST Root can be as simple as a rising edge detector that sends out a single-cycle pulse. It could optionally be preceded by some type of scaling circuit such as a divider to emit a beacon at some fraction of the RefClk frequency. A more general scaling facility could be a prescaler followed by a multiplier followed by a divider which provides a very general ratio of a subharmonic of RefClk For example: BeaconRate=(RefClk/Prescaler)*(Multiplier/Divider). If this example is inconvenient to implement, it should be recognized that it is exactly what is contained in an off-the-shelf Integer-N PLL. The Beacon signal propagates in a ring around the chip, with a connection to each C2C controller; the Beacon is terminated when it gets back to the MkBeacon block in the root. If the processor or FPGA device is not the MST Root, then one of the C2C links is a child to a parent that is in a higher level of the MST. When the child C2C link receives a Beacon from the dedicated parent, it emits a Beacon onto the ring so that every other C2C controller gets it. Each C2C controller that is configured to be a parent to a child device sends a Beacon as a bit in the header of the very next packet to be sent. This time the Beacon goes around the ring until it gets back to the child C2C where it is terminated. As the Beacon passes the “Toggle/MonoStable” module, it is wave-shaped into a lower frequency signal and emitted on a GPIO pin as GtsClk. The wave-shaping could be as easy as toggling on each Beacon to produce a ½ frequency signal, or triggering a counter to behave as a MonoStable Multivibrator to stretch the single-cycle pulse to, for example, be 1000 cycles long.

The propagation of the Beacon around the ring can be performed any of several ways. For example, the most common approach is to use the ChipClock to pipeline the signal; if CPS is being used to manage power, the CPS clock period may change which would introduce variation and increased latency on the Beacon signal, which is undesirable, even if it might be tolerated by the Network Synchronizer. A more consistent propagation delay would result if an auxiliary fixed-frequency clock were provided at each pipeline stage to keep the latency as low as the physical wires allow, and also to minimize the variation of the Beacon signal delay. An iconoclastic approach would be to have the Beacon sent as an untimed signal, with CDC metastability synchronizers at each destination. Ironically, this is probably the lowest latency method, but it may not appeal to digital discrete time system true believers because the arrival time is somewhat non-deterministic, although again the network synchronizer may tolerate it well.

The Beacon ring is a wire that circumnavigates the chip, with each C2C reading the value and forwarding it to a child if appropriate. The Beacon ring signal terminates at the point of origin, whether that is the MkBeacon module, or a C2C that received the Beacon from a parent in another processor. Obvious alternatives to implement the Beacon ring signal would be to use a fixed frequency clock, or the Chip Clock (which may not be fixed frequency if CPS is being used. The minimum latency approach is to use an unpipelined signal. The benefits of an unpipelined signal include: smaller area, minimal power (no pipeline stages), and minimum latency. For this approach, the same as most other approaches, a CDC metastability mitigation circuit would be needed at each C2C or off-chip interface. With an unpipelined signal, a differential pair could be used to improve fault tolerance and noise immunity, such as a Beacon is recognized only if the Beacon+signal is true and also that the Beacon-signal is false; and a space between Beacon signals must be Beacon+false and Beacon-true. The signal is considered invalid if Beacon+ and Beacon− are both true or both false. A toggle flop can be used to filter out false beacon signals by setting the toggle when a Beacon is received, and resetting the toggle when an inter-Beacon space is received. A deterministic pipelined Beacon ring signal may be easier to validate during a deterministic ATE testing than an unpipelined differential pair.

Global Time Synchronization (GTS) eliminates relative drift in large-scale networks of processor and FPGA chips. GTS without Coax supports a graceful degradation if there is a fault in the Beacon distribution network, with crystal oscillator redundancy in each node to mitigate any master reference clock failure or clock distribution network failure. Note that GTS is not related to Ethernet clock synchronization protocols, such as IEEE 1588 Precision Time Protocol (PTP), Network Time Protocol (NTP), or SyncE. GTS w/o Coax Requirements/Features are defined as follows:
Zero SW overhead
No separate coax wiring
No constraints on sub-graph connectivity using either processor or FPGA links of any length
Minimal processor HW overhead
Single Beacon header bit to eliminate packet arbitration and latency
Negligible impact on inter-device communication latency and bandwidth
Independent reference clock periods
Supports fully independent CPS clock periods for every clock cycle for every processor or FPGA device
GTS w/o Coax Optimizations:
   Use Dijkstra's algorithm for weighted or unweighted edges to construct an optimal Beacon Minimum Spanning Tree (MST)
   Use unpipelined or pipelined wiring for Beacon Ring
   Use differential pair and LPF techniques for beacon noise immunity

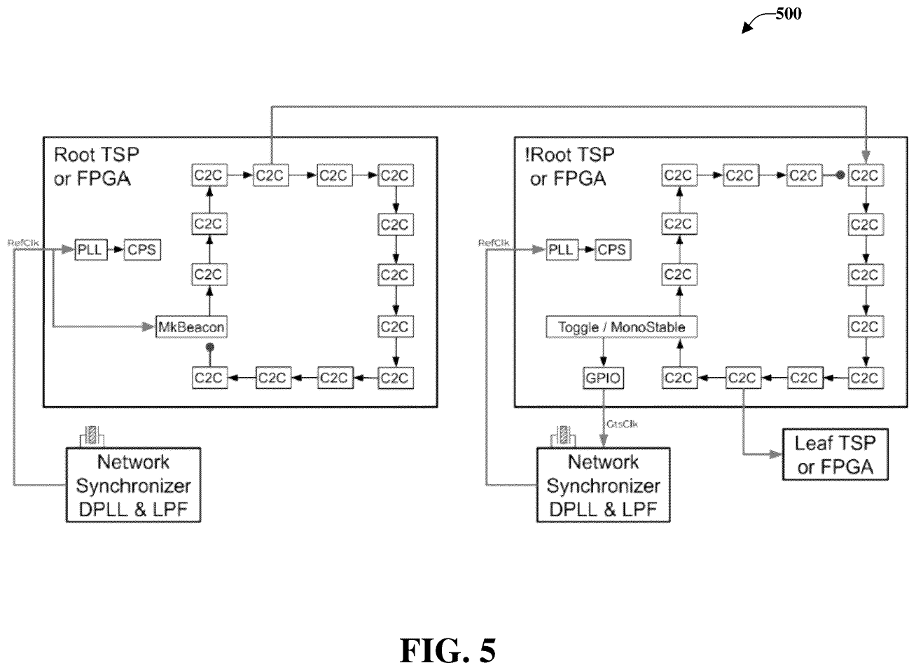

See FIG. 5 which depicts a circuit diagram for a system having Global Time Synchronization without coax. One concern is how well does GTS without Coax tolerate a potentially large amount of jitter on the GTS clock signal. It is noted that it is the explicit purpose of the commercial Network Synchronizer chip to properly deal with jitter on the gtsClk signal, and the specs of that Network Synchronizer chip (or the equivalent circuit integrated in a processor) will directly determine the system-level performance characteristics of a large-scale system comprising a plurality of racks.

Given that the DPLL in the network synchronizer tracks changes in the GTS edge position with a low-pass filter, the output of the Network Synchronizer should resemble the average frequency. If any GTS clock pulses are not recognized by the network synchronizer, this will cause the average frequency to be corrupted. It is noted that an extra or missing gtsClk would happen if and only if a packet is uncorrectably corrupted. For many workloads, the system will necessarily need to restart from a previous checkpoint, and this in turn implies that the synchronous, deterministic software alignment between all processor and FPGA devices will need to be reestablished, which fully resolves the erroneous Beacon. If a catastrophic failure is experienced in the form of an uncorrectable packet, GTS drift will probably not be the highest priority problem.

Considerations are given to how often the system would experience data packet corruption (E-18 with FEC but without Orthogonal Coding, or E-24 with Orthogonal Coding), and how much more graceful the degradation would be for GTS in the event of a catastrophic packet corruption event—e.g., the corrupted data would require an immediate restart from a previous checkpoint, but the GTS system could gracefully tolerate some designated number of extra or missing Beacon signals by adding an extra FIFO stage for each erroneous bit that can be tolerated before the restart is performed so that, for example, exception-handling diagnostics can be reliably performed.

To simulate the behavior of a system, a simulation model of the Network Synchronizer chip can be requested from the vendor. If such a model is not provided, one can be constructed using the datasheet specifications of the Network Synchronizer device.

A platform to implement a prototype can be developed empirical qualification of this synchronization system can be performed on the lab bench—it is the codename AXL blade. It has essentially everything needed, including all of the necessary network synchronizer chips, and even a convenient FPGA to implement a prototype of BeaconRing functionality. A programmable path from an FPGA GPIO pin can be added to obtain the gtsClk Network Synchronizer input pin. By implementing prototype BeaconRing functionality in the existing FPGAs on the AXL blades, a prototype for a V2 system can be developed and may even possibly be able to eliminate the requirement for coax wiring in AXL. The uncertainty about using this in a production AXL system follows from the absence of the Beacon Bit in the packet header emitted by Alan processor chips. An AXL system configured to prototype the BeaconRing would need to use a substitute such as a dedicated Beacon Packet, and the FPGAs would need to be wired in a Minimum Spanning Tree from a root device that serves as the Master Clock Reference. The dedicated Beacon Packet brings all of the ugly arbitration, worse beacon latency and latency variation, worse data plane latency, and worse data plane throughput that the Beacon header bit would solve. In an alternative ECIN, it is possible to add a FPGA-based GPIO pin path to the Network Synchronizer. This path could be implemented by adding a MUX chip, or by putting pads on the PCB to optionally install an SMA connector that could be cabled to the Network Synchronizer input in the same chassis. Additional considerations include the possibility of reverse flow of synchronization signals from a designated blade FPGA GPIO pin to the chassis power supply controller board for the chassis-wide Network Synchronizer to distribute the save reference uniformly to all of the blades in that chassis.

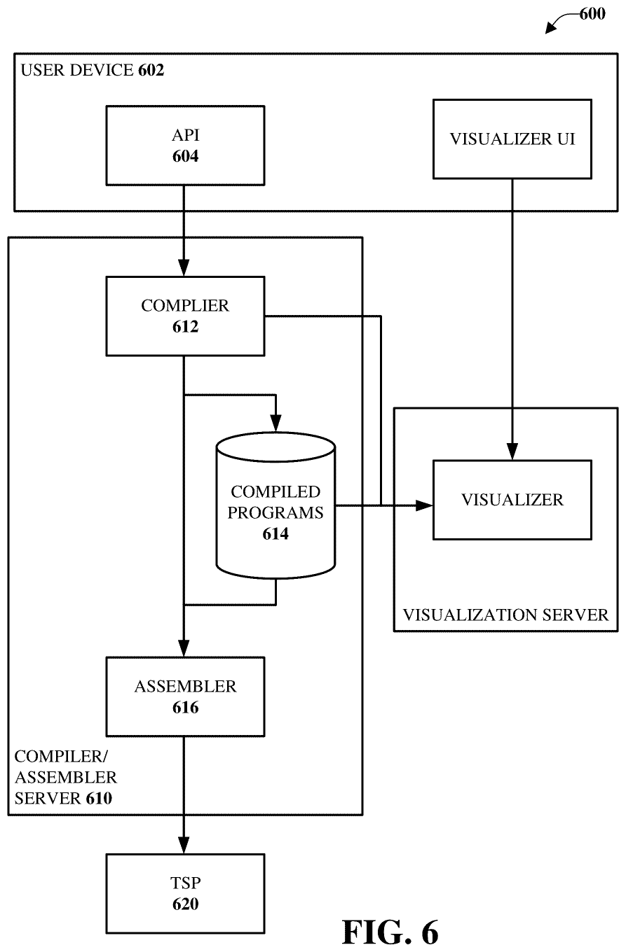

FIG. 6 illustrates a system 600 for compiling programs to be executed on a tensor processor, and for generating power usage information for the compiled programs, according to an ECIN. The system 600 includes a user device 602, a server 610, and a processor 620. Each of these components, and their sub-components (if any) are described in greater detail below. Although a particular configuration of components is described herein, in other ECINs the system 600 have different components and these components perform the functions of the system 600 in a different order or using a different mechanism. For example, while FIG. 6 illustrates a single server 610, in other embodiments, compilation, assembly, and power usage functions are performed on different devices. For example, in some embodiments, at least a portion of the functions performed by the server 610 are performed by the user device 602.

The user device 602 comprises any electronic computing device, such as a personal computer, laptop, or workstation, which uses an Application Program Interface (API) 604 to construct programs to be run on the processor 620. The server 610 receives a program specified by the user at the user device 602, and compiles the program to generate a compiled program 614. In some embodiments, a compiled program 614 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 612 is a TensorFlow compiler and the processor 620 is a tensor processor (e.g., a tensor streaming processor (processor). In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 620 is a tensor processor having a functional slice architecture, the compiler 612 generates an explicit plan for how the processor will execute the program, by translating the program into a set of operations that are executed by the processor 620, specifying when each instruction will be executed, which functional slices will perform the work, and which stream registers will hold the operands. This type of scheduling is known as “deterministic scheduling.” This explicit plan for execution includes information for explicit prediction of excessive power usage by the processor when executing the program.

The assembler 616 receives compiled programs 614, generated by the compiler 612, and performs final compilation and linking of the scheduled instructions to generate a compiled binary. In some embodiments, the assembler 616 maps the scheduled instructions indicated in the compiled program 612 to the hardware of the server 610, and then determines the exact component queue in which to place each instruction.

The processor 620, for example, is a hardware device with a massive number of matrix multiplier units that accepts a compiled binary assembled by the assembler 616, and executes the instructions included in the compiled binary. The processor 620 typically includes one or more blocks of circuitry for matrix arithmetic, numerical conversion, vector computation, short-term memory, and data permutation/switching. Once such processor 620 is a tensor processor having a functional slice architecture. In some embodiments, the processor 620 comprises multiple tensor processors connected together.

### Example Processor

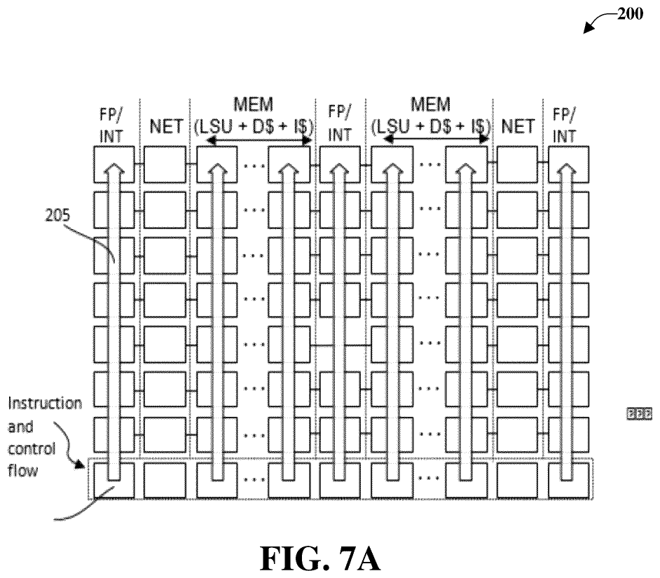

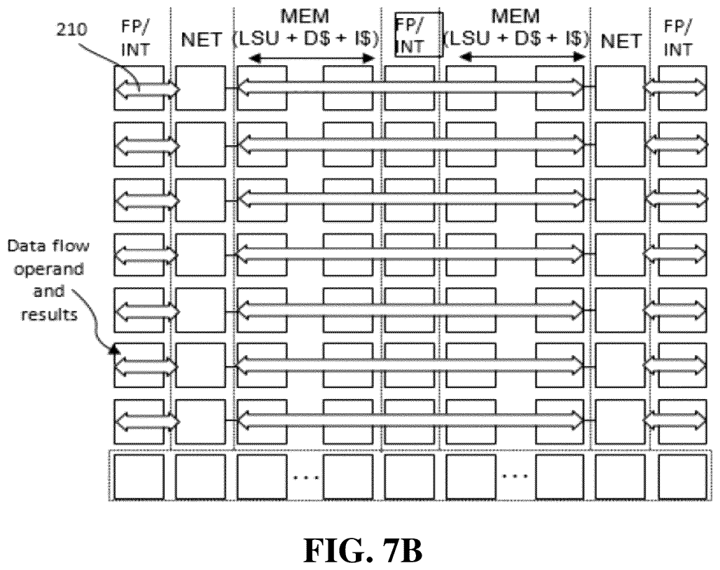

FIGS. 7A and 7B illustrate instruction and data flow in a processor 200 having a functional slice architecture, in accordance with some embodiments. One enablement of processor 200 is as an application specific integrated circuit (ASIC), and corresponds to processor 620 illustrated in FIG. 6.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In other embodiments, each tile may include an aggregation of functional units such as a tile having both MEM and execution units by way of example. As illustrated in FIGS. 6A and 6B, each slice corresponds to a column of N functional units extending in a direction different (e.g., orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 220 that connects a row of functional units of adjacent slices is referred to as a “super-lane,” and comprises multiple data lanes, or “streams.” each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 7A illustrates the flow of instructions within the processor architecture, while FIG. 7B illustrates the flow of data within the processor architecture. As illustrated in FIGS. 7A and 7B, the instructions and control signals flow in a first direction across the functional units of processor 200 (e.g., along the length of the functional slices 205), while the data flows 220 flow in a second direction across the functional units of processor 200 (e.g., across the functional slices) that is non-parallel to the first direction, via the communication lanes (e.g., super-lanes) connecting the slices.

In some embodiments, the functional units in the same slice execute instructions in a “staggered” fashion where instructions are issued tile-by-tile within the slice over a period of N cycles. For example, the ICU for a given slice may, during a first clock cycle, issues an instruction to a first tile of the slice (e.g., the bottom tile of the slice as illustrated in FIG. 7B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results flow in the opposite direction where they are then written back to memory. For example, a first data flow from a first memory slice flows in a first direction (e.g., towards the right), where it is intercepted by a VXM slice that performs a vector operation on the received data. The data flow then continues to an MXM slice which performs a matrix operation on the received data. The processed data then flows in a second direction opposite from the first direction (e.g., towards the left), where it is again intercepted by VXM slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by VXM slice before traveling to the second MXM slice. The results of the matrix operation performed by the second MXM slice then flow in the first direction back towards the second memory slice.

In some embodiments, stream registers are located along a super-lane of the processor. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the processor's basic data type is an INT8, each register may be 8-bits wide). In some embodiments, in order to support larger operands (e.g., FP16 or INT32), multiple registers are collectively treated as one operand, where the operand is transmitted over multiple streams of the super-lane.

All of these functional features-superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

### Processor Power Control

In some of the ECINs disclosed here, clock period synthesis is used to achieve more efficient power management in a processor, especially tensor and graphical processors which perform billions and trillions of floating-point operations per second. A large number of such operations that are executed at the same time, or nearly at the same time, can create potentially damaging electric current flows in the processor, which can cause heat flows that are damaging, making it important to minimize changes in current flow (di/dt) during execution of a program.

In some of the ECINs disclosed herein, clock period synthesis is enabled by adding additional hardware and software instructions to a processor.

### Clock Period Synthesis—Hardware

In some of the ECINs disclosed herein, the processor comprises the following four elements: a High Frequency Clock (HFC) generated by an on-chip Phase-Locked Loop (PLL) circuit where the period of the HFC is preferably shorter than the nominal period of the main clock (ChipClock) period; a waveform generator to produce the more useful ChipClock waveforms disclosed herein; a duration logic block to preload values for the waveform generator; and an instruction control unit (ICU) to provide instructions for the CPS methods disclosed herein.

ChipClock waveform resolution typically is half of the HFC period, representing the smallest increment of change for the ChipClock period. The duration of half of the HFC period is called the High Frequency Clock Phase Period (HFCPP). For example, the HFC period for the processor tensor processor from Groq, Inc., is about 25.58 picoseconds.

As an example, an HFC period that is one-eighth the nominal ChipClock period enables an HFCPP that is 1/16th of the nominal ChipClock period. This HFCPP enables a clock period waveform resolution granularity of plus-or-minus 6.25%.

ChipClock periods that are enabled are integer multiples of the HFCPP. The multiple does not need to be a power of two. The chip reset signal sets the ChipClock period to the Default ChipClock duration. The DefaultChipClock period can be overwritten using a configuration register. The configuration register also has a MinClockPeriod field which is the minimum number of HFCPP periods allowed for ChipClock, and a EnableClockChange flag that prohibits any ChipClock period changes. The default value of the MinClockPeriod minimum ChipClock period register is equal to the hardware value of the DefaultChipClock period. The DefaultChipClock period should never be set to a value less than the MinClockPeriod. The default value of the EnableClockChange flag is FALSE to prohibit clock period changes until a configuration register write operation sets the value of the flag to TRUE. After the processor has booted (restarted) and a program is running, if the EnableClockChange flag is set to TRUE, ChipClock period changes are determined exclusively by subsequent software instructions, and a configuration register write operation should not be used to change the period until after the user instructions have completed.

The minimum ChipClock period is eight times the HFCPP, where the minimum ChipClock high time is four times the HFCPP, and the minimum low time is four times the HFCPP, forming a waveform with a 50/50 duty cycle. The minimum ChipClock period constraint implies that the HFC period should be less than or equal to one-fourth of the shortest ChipClock period that will be used. That is, the HFC frequency is at least four times the frequency of the fastest ChipClock frequency that is used.

The longest possible ChipClock period is limited by either the maximum size of the Target ChipClock Period field in the instruction format which supports the use of up to 2\hat{ }9=512 HFCPP long clock periods, or by the number of shift register stages implemented in the CCU (Chip Control Unit), whichever is smaller. The instruction format and CCU shift register properties are described in respective sections below.

Automatic Ramp from One Period to the Next Period

In some of the ECINs disclosed herein, processor current flow changes (di/dt) are managed by setting the Slope, Steep, and Linear fields in a CPS instruction word to values that increase or decrease the rate of change of the current drawn by the processor per unit time. This capability is used to control the rate of change in load current imposed on the voltage regulator during large step increases in load current, or during large release reductions in load current (when fewer instructions are being executed).

When Linear=0 and Steep=0, the ChipClock period is increased or decreased by another unit of HFCPP after each time Slope ChipClock periods have been completed, until the ChipClock period equals the TargetPeriod. A larger Slope value will cause the di/dt value to be smaller. When Steep=0, Rise=1, and Run=Slope, the Ramp angle=Rise/Run.

When Linear=0 and Steep=1, the ChipClock period is increased or decreased by Slope units of HFCPP after each ChipClock period has been completed, until the ChipClock period equals the TargetPeriod. A larger Slope value will cause the di/dt value to be larger. When Steep=1, Rise=Slope, and Run=1, the Ramp angle=Risc/Run.

When Linear=1, Steep=0 and Slope=1, the ChipClock period is increased or decreased slowly in a way that limits the di/dt change to a small, fixed value. The change in ChipClock period from one period to a new period that is one HFCPP unit larger or smaller is spread across several blocks on ChipClock periods so that the average di/dt during each block of ChipClock periods is smaller than some specified di/dt limit value. For example, if the current ChipClock period is 13 HFCPP units and the target new ChipClock period is 14 HFCPP units, the di/dt step change would equal one divided by 13, or 5.69%. Assuming a specification that di/dt must not exceed 1%, then the period transition from 13 to 14 must be spread over Ceiling (5.69)=8 blocks, where each block is 8 ChipClock periods long, and the duration of each ChipClock period in each block is either 13 or 14, and the number of ChipClock periods that are 14 in each block increases by one for each block moving from all 13 to all 14 after 8 blocks. The position of each shorter or longer period is chosen to be spread out as much as possible to minimize the local average change over any interval of ChipClock periods.

### Instructions for Runtime Acceleration

With adequate timing information describing different timing support for different subsets of instructions, the compiler can identify sets of instruction cycles that may operate at a shorter clock period than other instruction sets.

To exploit this opportunity, the hardware design process for a processor that uses CPS runtime acceleration needs to include additional timing closure activities. For example, a processor designer partitions the chip into several subsets of instructions or circuit operations. At least one of these partitions is designed to run faster than at least one other partition that runs slower. The designer closes timing, for example, at 1.1 GHZ, and closes timing at 1.2 GHz. The designer should give special attention when closing timing on a circuitry subset of the chip, to prevent any metastability-triggering situations.

Prior to, or during execution, the ChipClock period is configured to satisfy the most stringent requirements of any instruction that is active. This may be performed in the processor instruction sequence compiler prior to execution, or it may be done by a circuit or processor on-the-fly during runtime execution. An active instruction is either a newly dispatched instruction, or the subsequent cycles of a multi-cycle instruction that was dispatched previously. For example, the ChipClock period is set to the longest period required by any active instruction. If all active instructions are in the faster partition for certain clock cycles, then the chip will run faster than during other clock cycles when some active instructions are from the slower partition.

### Clock Period Synthesis Circuit Description

As noted in co-pending commonly assigned U.S. Non-Provisional patent application Ser. No. 18/323,188 filed May 24, 2023, entitled “Clock Period Synthesis For Fine-grain Power Management, a relatively small number of logic gates are required for CPS.

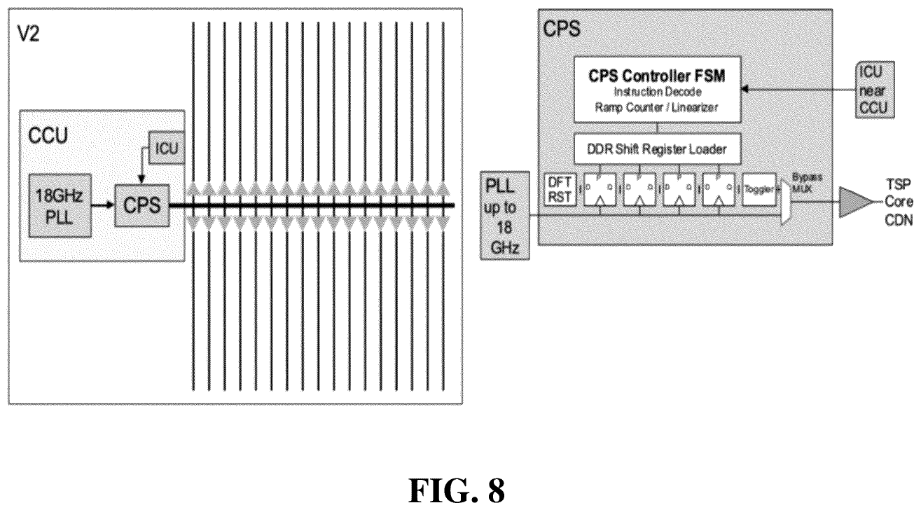

FIG. 8 depicts an exemplary CPS circuit that is physically implemented in Chip Control Unit (CCU), as part of the PLL/Clock Control Module, and the CPS ICU uses the nearest, most appropriate ICU block. For example, for the processor tensor processor available from Groq, given that the main vertical clock spine is located along the central axis of the chip, a preferred location of the CCU is as close as possible to the central axis at the bottom center of the chip. This location makes it desirable to locate the CPS ICU near the ICU blocks that serve VXM slices near the center of the chip. The root of a clock distribution network may be located in other configurations on other chips, and there may be more than one clock generated on any particular chip.

Also depicted in FIG. 8 is a toggle flip-flop structure used by the CPS, with programmable delays to determine the high-time and low-time of ChipClock. Programmable delays are implemented as shift registers that are clocked by a high frequency clock that operates at, for example, eight times the nominal chip clock frequency. The duration of each phase of each clock cycle is determined by ‘next state’ values loaded into the high state and low state shift registers, respectively. Next state logic preloads the shift registers with new period values on respective ChipClock edges. For a given resolution, the dynamic power of the shift registers can be cut in half by using rising and falling edges to implement half-cycle resolution, where the precision of this operation depends on the degree of symmetry in the duty cycle of the high frequency reference clock. Power and implementation area can be further reduced by reusing a single shift register for both the high and low phases of the generated clock waveform.

The period of the high frequency clock and the number of shift register stages required for CPS are together determined by the nominal ChipClock period, the desired waveform granularity, and the maximum desired clock period for low power operating modes. For example, with a nominal 1 nS ChipClock period, 6.25% waveform granularity, and a maximum ChipClock period that is 16 times the nominal ChipClock period, the number of shift register stages required would be as follows.

The duration of HFCPP is the ChipClock period times the waveform granularity percentage, for example, 1 nS*6.25%=0.0625 nS (nanoseconds). The period of the HFC is two times the duration of HFCPP, which here equals 2*0.0625 nS=0.125 nS, so the HFC would be 8 GHz. The number of shift register stages required is the maximum ChipClock period divided by the HFC period, or 16 nS/0.125 nS=128 DFF stages, plus a few extra DFFs to implement one HFCPP resolution.

### Clock Period Synthesis—Software Requirements CLOCK PERIOD SYNTHESIS INSTRUCTIONS

CPS instructions are intentionally orthogonal to other functional instructions, which means that the functional instruction sequence are scheduled by the compiler or human programmer without consideration of CPS instructions, and then CPS instructions are determined by an efficient post-processing operation based on the available instruction sequence. This orthogonality facilitates much faster program compilation than would be possible if power requirements were applied as constraints during the determination of the optimized instruction sequence. CPS instructions can be dispatched as often as once per ChipClock. In the absence of any CPS instructions for a job, the ChipClock period defaults to a default value at boot time. A configuration register write can be used to overwrite the HW default ChipClock period. Chip Reset sets the ChipClock period to the default value. Cumulative clock periods are aligned at data transfer times, which should be considered invariant during instruction scheduling by the compiler. The Compiler should keep a tally of the real-time duration of the instructions executed on each chip in a multi-processor system. The real-time values should be deterministically aligned at data transfer times. The Compiler has a great deal of flexibility to optimize clock durations on each individual processor, although the longest duration required during each synchronization interval will dominate.

Software control of ChipClock periods is achieved by configuring four CPS instruction parameter values: TargetPeriod, Slope, Steep, and Linear. All four parameters are set in each instruction. The TargetPeriod specifies the number of HFCPP periods that will be in each ChipClock period, where the high time and low time are balanced as much as possible by the hardware algorithms. A separate instruction is used to configure the Duration module to operate with an asymmetric duty cycle for circuits such as memory arrays that require an asymmetric duty cycle for optimized operation.

To control processor current flows, di/dt, it is desirable to spread out changes in the magnitude of current drawn by the processor. The Slope, Steep, and Linear parameters specify the size of the incremental steps taken during each ChipClock period change while transitioning from the current value of ChipClock to the TargetPeriod.

### CPS Instruction Word Format

| Bit | | |
|---|---|---|
| Position | Field Name | Field Description |
| 31:30 | ReservedBits | Two Reserved bits (set to zero by default) |
| 29:21 | TargetPeriod | ChipClock will transition to TargetPeriod according to the |
| | | Slope, Steep, and Linear options below |
| 20:12 | Slope | ClockPeriod rate of change toward TargetPeriod; |
| | | If (Slope == 0) ClockPeriod = TargetPeriod immediately |
| 11 | Steep | If (Steep == 1) then Slope is the number of HFCPP units |
| | | add/subtracted during each ChipClock period; |
| | | If (Steep == 0) then ChipClock period is changed by one |
| | | HFCPP unit after Slope ChipClock periods |
| 10 | Linear | If (Linear == 1) then the Slope is linearized |
| 9 | MostlyHi | Duty Cycle biased to be high longer for odd period |
| | | durations |
| 8:6 | ExtraLong | Zero to 5 extra HFCPP units added to Hi or Lo phase |
| 5 | Lengthenable | Indicates clock periods eligible to be lengthened for Flit |
| | | Rate Synchronization |
| 4 | Shortenable | Indicates clock periods eligible to be shortened for Flit |
| | | Rate Synchronization |
| 3:0 | OpCodeRes | Op Code = 0x06 |

The CPS instruction word format uses 9 bits for the TargetPeriod field, e.g., bits 21-29.

New CPS Instructions immediately preempt previously dispatched instructions, even if the ChipClock period is not yet equal to the TargetPeriod specified in the previous instruction (e.g., the ChipClock period is still changing). Extra care is advised when the Compiler calculates the timing consequences of a preempted CPS instruction.

The Linear field linearizes di/dt as the ChipClock period increases or decreases for small values of the ChipClock period. Without linearization, di/dt would be much larger for each change in ChipClock period for smaller ChipClock period durations. The pattern is a concave curve that has the functional shape of 1/x. By reducing the di/dt for smaller ChipClock periods, the di/dt is linearized, as shown in the Linearization Plot and the Linearization Table below.

Linearization is activated when (Linear==1 AND Steep==0 AND Slope==0), causing the CPS FSM to emit a preselected sequence of N period values from a stored table, each period value is repeated LinearizationBlock (LB) times, thus defining the next LB*LB clock periods. N is a function of the target clock period. For example, when LB=15 the destination clock period is at 84 ticks, and similarly for other values of LB: 13 @ 9, 12 @ 10, 11 @ 11, 10 @ 12, 9 @ 13, 8 @ 14-15, 5 @ 16-15, 6 @ 18-21, 5 @ 122-126, 4 @ 25-34, 3 @ 35-51, and 2 @ 52-101.

### Operating Point Voltage and Frequency

The ability to set safe and reliable operating conditions is essential for electrical systems. In one ECIN, for processor processors available from Groq, the main operating Vdd voltage for the processor can be changed via the Board Management Controller (BMC) using a PCB microcontroller that interfaced with the voltage regulators through Serial Peripheral Interface (SPI) bus ports, and similarly the PCB clock generator frequency can be set to provide an appropriate reference clock frequency for the on-chip PLL. Changes to Vdd or the Reference Clock Frequency are made between jobs. Changing the external Reference Clock Frequency while the processor is operating is not advised because invalid clock periods may result as the PLL tracks to lock-in on the new reference clock frequency. In the best case, if the processor continued to operate, the latency would be indeterminate because PLL tracking has significant uncertainty, and the power would also be less predictable due to the changing clock frequency. Power levels would also be uncertain during the time it takes a Vdd level change to propagate through the voltage regulator to slew the output voltage to the new setpoint.

Detailed Description—Technology Support from Data/Instructions to Processors/Programs

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1559 [CAFC, 1994]). Data and information are physical objects, for example binary data (a ‘bit,’ usually signified with ‘0’ and ‘1’) enabled with two levels of voltage in a digital circuit or electronic component. For example, data can be enabled as an electrical, magnetic, optical, or acoustical signal or state; a quantum state such as a particle spin that enables a ‘qubit;’ or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm,’ ‘method,’ ‘procedure,’ ‘(sub) routine,’ ‘protocol,’ ‘recipe,’ and ‘technique’ often are used interchangeably with ‘process,’ and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or at about the same time.

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills, and styles are authored, structured, and enabled—objectively—as processes and/or rules—e.g., knowledge and learning as functions in knowledge programming languages.

As used herein, the term ‘component’ (also signified by ‘part,’ and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit-such components include resistors, memristors, capacitors, magnetic inductors, crystals, Josephson junctions, transducers, sensors, antennas, waveguides, etc. Active electronic components require a source of energy and can inject energy into a circuit-such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures-such components include switches, relays, protection devices (e.g., fuses, circuit breakers), heat sinks, fans, cables, wires, terminals, connectors, and printed circuit boards.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit,’ ‘IC,’ ‘chip,’ ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules,” as opposed to the doublethink of deleting only one of the “(patentable).”

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals [FACT]. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (′I/O′) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor,’ it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, can also transform data and information. No scientific evidence exists that any of these technological processors are processing, storing, and retrieving data and information, using any process or structure equivalent to the bioelectric structures and processes of the human brain.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specific network interfaces (‘interface’ defined below) (e.g., an application program interface (‘API’) that signifies functions and data structures to communicate with the remote process).

As used herein the term ‘processors’ can also comprise additional modules such as an FPGA device. For example, a group of processors can include modules that interface additional memory such as DRAM or SRAM devices with a FPGA used to couple the memory to the processor over the C2C link. Accordingly, a processor may include companion modules even if not explicitly stated in an embodiment. In some embodiments, one or more of the processors may be replaced by modules that include FPGA implemented engines coupled to other processors or modules by the C2C links. Further, as used herein, the terms devices and modules can be used interchangeably.

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors, and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor, or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs, and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### Detailed Description—Technology Support General Computer Explanation

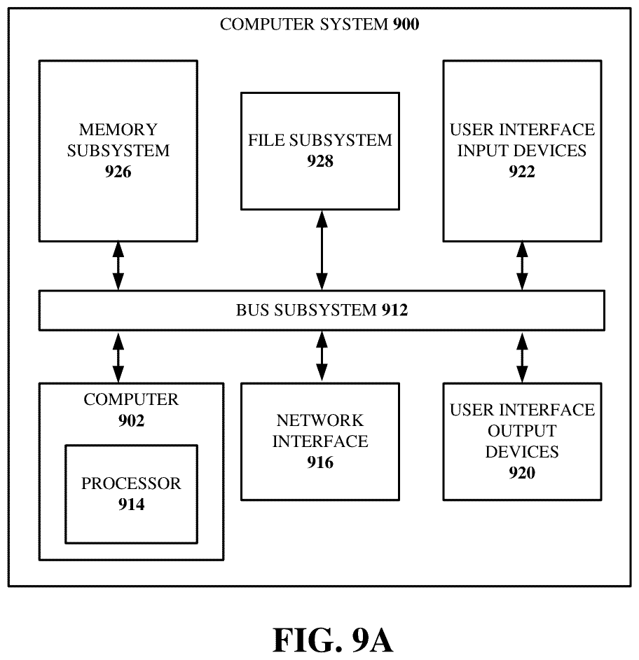

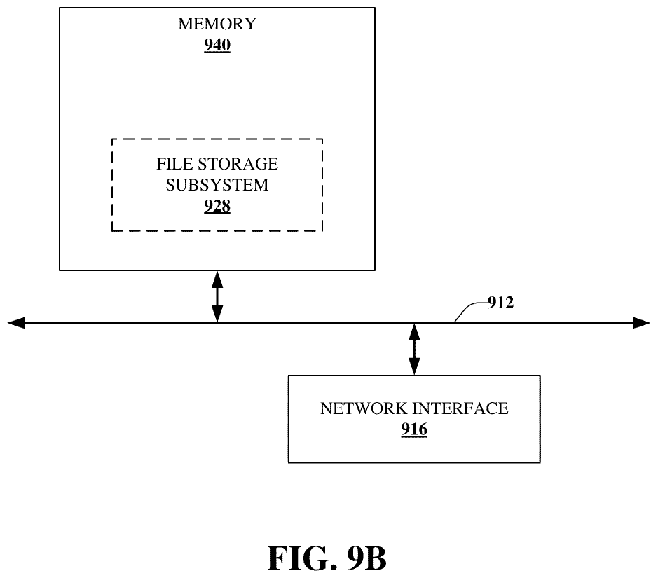

FIG. 9A and FIG. 9B depict computer systems suitable for enabling embodiments of the claimed inventions.

In FIG. 9A, the structure of computer system 910 typically includes at least one computer 914 which communicates with peripheral devices via bus subsystem 912. Typically, the computer includes a processor (e.g., a microprocessor, graphics processing unit, AI co-processor or digital signal processor), or its electronic processing equivalents, such as an Application Specific Integrated Circuit (‘ASIC’) or Field Programmable Gate Array (‘FPGA’). Typically, peripheral devices include a storage subsystem 924, comprising a memory subsystem 926 and a file storage subsystem 928, user interface input devices 922, user interface output devices 920, and/or a network interface subsystem 916. The input and output devices enable direct and remote user interaction with computer system 910. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server,’ as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Linux and/or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium, and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 910 depicted in FIG. 9A is intended only as an example. Many other structures of computer system 910 have more or less components than the computer system depicted in FIG. 9A.

Network interface subsystem 916 provides an interface to outside networks, including an interface to communication network 918, and is coupled via communication network (not shown) to corresponding interface devices in other computer systems or machines. Communication network can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/Rprocessor, IPX and/or UDP.

User interface input devices 922 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 910 or onto communication network. User interface input devices typically enable a user to select objects, icons, text and the like that appear on some types of user interface output devices, for example, a display subsystem.

User interface output devices 920 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 910 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 926 typically includes a number of memories including a main random-access memory (‘RAM’) 930 (or other volatile storage device) for storage of instructions and data during program execution and a read only memory (‘ROM’) 932 in which fixed instructions are stored. File storage subsystem 928 provides persistent storage for program and data files, and can include a hard disk drive, a floppy disk drive along with associated removable media, a CD-ROM drive, an optical drive, a flash memory such as a USB drive, or removable media cartridges. If computer system 910 includes an input device that performs optical character recognition, then text and symbols printed on paper can be used as a device for storage of program and data files. The databases and modules used by some embodiments can be stored by file storage subsystem 928.

Bus subsystem 912 provides a device for transmitting data and information between the various components and subsystems of computer system 910. Although bus subsystem 912 is depicted as a single bus, alternative embodiments of the bus subsystem can use multiple buses. For example, a main memory using RAM can communicate directly with file storage systems using Direct Memory Access (‘DMA’) systems.

FIG. 9B depicts a memory 940 such as a non-transitory, processor readable data and information storage medium associated with file storage subsystem 928, and/or with network interface subsystem 916, and can include a data structure specifying a circuit design. The memory 940 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred in to and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### Detailed Description—Semantic Support

The signifier ‘commercial solution’ signifies, solely for the following paragraph, a technology domain-specific (and thus non-preemptive—see Bilski): electronic structure, process for a specified machine, manufacturable circuit (and its Church-Turing equivalents), or composition of matter that applies science and/or technology for use in commerce to solve an unmet need of technology.

The signifier ‘abstract’ (when used in a patent claim for any enabled embodiments disclosed herein for a new commercial solution that is a scientific use of one or more laws of nature {see Benson}, and that solves a problem of technology {see Dichr} for use in commerce- or improves upon an existing solution used in commerce {see Dichr})—is precisely defined by the inventor(s) {see MPEP 2111.01 (9th edition, Rev. 08.2015)} as follows

a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 U.S.C. 102, for example, because it is ‘difficult to understand’ {see Merriam-Webster definition for ‘abstract’} how the commercial solution differs from equivalent prior art solutions; or

b) a new commercial solution is ‘abstract’ if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2015)} to be equivalent to the new commercial solution, and is thus unpatentable under 35 U.S.C. 103, for example, because it is ‘difficult to understand’ how the new commercial solution differs from a PHOSITA-combination/-application of the existing prior art; or

c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {see Katz} (or, e.g., circuit design) to be performed by the PHOSITA, and is thus unpatentable under 35 U.S.C. 112, for example, because it is ‘difficult to understand’ how to use in commerce any embodiment of the new commercial solution.

### Detailed Description—Conclusion

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function, or characteristic, it is within the knowledge and understanding of a skilled person to use such feature, structure, function, or characteristic in connection with another ECIN whether or not explicitly described, for example, as a substitute for another feature, structure, function, or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described, but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified, or incorporated with respect to any one ECIN also can be included with any other ECIN. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the Claims.

Provided herein is more efficient/useful electronic structure for tensor processors, comprising: a mechanism to align a processor chip clock to the rate of reception of flits from the parent in a spanning tree.

Also provided herein is more efficient/useful electronic structure for tensor processors, comprising: at least two deterministic processors having a mechanism to align the processor chip clock to the rate of reception of flits from the parent in a spanning tree.

A more efficient/useful electronic structure for tensor processors, comprising: a mechanism to align a processor chip clock to the rate of reception of flits from a parent in a spanning tree is also provided herein.

What is claimed is:

1. An electronic system for a plurality of processors in a parent-child network, comprising:
a digital counter circuit for counting flits (a unit of data) received by a child processor in the network from a parent processor; and
a process for synchronizing the clocks of the patent and child processors by a) comparing counts of flits that are sent and received by the parent processor and the child processor, and b) increasing or decreasing the speed of the clock of the child processor depending on the difference in the counts of the number of flits received by the child processor, and the number of flits sent by the parent processor.

2. The electronic system of claim 1, where the expected number of flits sent by the parent processor is calculated at the time when software to be executed on the child processor is compiled.

3. The electronic system of claim 1, where the clocks of the parent and child processors are indicated to be aligned if the difference in the counts of the numbers of flits sent and received are approximately zero.

4. The electronic system of claim 1, where if the counter and comparison indicates that fewer flits are received than expected, then the child processor clock lengthens on or more of its clock periods relative to the clock of the patent processor.

5. The electronic system of claim 1, where if the counter and comparison indicates that more flits are received than expected, then the child processor clock shortens on or more of its clock periods relative to the clock of the patent processor.

6. The system of claim 1, wherein the flits are flow control units.

7. The system of claim 1, wherein the flits are flow control digits.

8. The system of claim 1, wherein each flit represents a fraction of a packet.

9. The system of claim 1, wherein each flit carries a few bits of information.

10. The system of claim 1, wherein each flit carries a few bytes of information.

11. An electronic structure for a plurality of processors, comprising:
at least two processors having a process and a circuit to align the clock of a child processor to the clock of a parent processor based on any difference in the number of flits sent by the patent and received by the child.

12. The electronic structure of claim 11, wherein, the expected number of flits to be received by the child processor is calculated at the time when software to be executed on the child processor is compiled.

13. The electronic structure of claim 11, where the clocks of the parent and child processors are indicated to be aligned if the difference in the counts of the numbers of flits sent and received are approximately zero.

14. The electronic structure of claim 11, where if the counter and comparison indicates that fewer flits are received than expected, then the child processor clock lengthens on or more of its clock periods relative to the clock of the patent processor.

15. The electronic structure of claim 1, where if the counter and comparison indicates that more flits are received than expected, then the child processor clock shortens on or more of its clock periods relative to the clock of the patent processor.

16. The system of claim 1 wherein the chip clock is a Tensor Streaming Processor chip clock and the chip clock sets a rate of reception of flits from a parent processor, wherein the parent is one of a processor or a FPGA device.

17. The system of claim 11 wherein the chip clock is a Tensor Streaming Processor chip clock and the chip clock sets a rate of reception of flits from a parent processor, wherein the parent is one of a processor or a FPGA device.
